(19) United States
(12) Patent Application Publication
(10) Pub. No.: US 2007/0078943 A1
(43) Pub. Date: Apr. 5, 2007

(54) Message based application communication system

(76) Inventors: Kenneth Daniels, Essex, CT (US); Roman Kresina, Oxford, CT (US)

Correspondence Address: KENYON & KENYON LLP, 1500 K STREET N.W., SUITE 700, WASHINGTON, DC, 20005, US

(21) Appl. No.: 11/243,409

(22) Filed: Oct. 4, 2005

(51) Int. Cl. G06F 15/16

(52) U.S. Cl. 709/217

(57) ABSTRACT

A method for communicating between applications on a network is provided. A first server having associated applications and a second server having associated applications are provided. The first and second servers are bridged together with a bridge functionality having at least one subscription list. A message is sent from at least one of the associated applications on the first server to the first server. The message is sent to the associated applications on the first server subscribing to the message and to the bridge functionality. The message is added to the at least one subscription list. The message is sent to the second server and the associated applications on the second server that subscribe to the message. The bridge functionality determines if the message is to be sent to the second server and the associated applications on the second server.

### BACKGROUND

1. Field of the Invention

The present invention relates to a software component communication system and, more particularly, to a software component communication system having an XML message bus.

2. Brief Description of Related Developments

When software systems are built from a variety of components (both new and existing) it becomes clear that a means of communication must be provided so that these various software components can “talk” to each other. This communication is vital because it allows each component in the system to provide unique services to other components.

For instance, there may be one component that handles aggregating mailing machine data, another component that knows how to control a specific mailing machine, and yet another that can produce reports based on accounting data. Each of these components has a specific purpose and some rely on the services offered by the other components to successfully perform their specific task. The component that aggregates mailing machine data relies on the services offered by the mailing machine controller components. Also, the component that produces reports relies on the aggregator components for the report data.

This communication between these various components can be handled quite easily if each component is allowed to have direct knowledge of the components it depends on so that it can make the appropriate function calls on those components. This works quite well until one of those components needs to change one of its functions. This type of communication between components is said to be very brittle because changing one component could break the functionality of another dependent component. Because software systems tend to be very dynamic these types of brittle dependencies between components make the overall system very fragile. Not only does it often prevent the individual components from being reused, it also requires a very high level of coordination between components. This often stifles the growth of the individual components in the system.

In recent years, message based communication between discreet software components has become very popular because it makes the overall software system much more flexible and less adverse to change. In message based communication architectures the various software components agree on a set of messages in a known format that can be used to communicate with each other. As long as each component agrees on these messages the internals of these components are free to change. Also, employing message based communications allows the individual components to be implemented on any platform using any computer language that is capable of producing and consuming the agreed upon message format. Now instead of a brittle and tightly-coupled interface between components, using a message based architecture, systems can employ a much more open and loosely-coupled interface between components.

Many message based systems use an XML format for the messages that are sent between components. XML is a text based format that is both self describing and extensible. Being text based makes it ideal in that all computer systems know how to process text. XML is a markup language (much like HTML) where each piece of data in an XML document is enclosed between a beginning and ending tag that describes the meaning of that data. This is what is meant when it is said that XML is self-describing. Also, the names of these tags are not predefined allowing the architect the ability to define their own tags.

### SUMMARY

The present invention is directed to a message based communication system for network applications. In one embodiment, a method for communicating between applications on a network is provided. A first server having associated applications and a second server having associated applications are provided. The first and second servers are bridged together with a bridge functionality having at least one subscription list. A message is sent from at least one of the associated applications on the first server to the first server. The message is sent to the associated applications on the first server subscribing to the message and to the bridge functionality. The message is added to the at least one subscription list. The message is sent to the second server and the associated applications on the second server that subscribe to the message. The bridge functionality determines if the message is to be sent to the second server and the associated applications on the second server.

In accordance with an exemplary embodiment, a computer network is provided. The computer network having a first server having associated applications, a second server having associated applications and a bridge functionality having at least one subscription list. The bridge functionality connecting the first and second server. The bridge functionality determines if a message is to be sent from the first server to the second server.

### BRIEF DESCRIPTION OF THE DRAWINGS

The foregoing aspects and other features of the present invention are explained in the following description, taken in connection with the accompanying drawings, wherein:

FIG. 1 is an diagram of a communication network in accordance with an exemplary embodiment;

FIG. 2 is another diagram of a communication network in accordance with another exemplary embodiment;

FIG. 3 is a diagram of a communication network in accordance with yet another exemplary embodiment;

FIG. 4 is a diagram of a component of the communication network in accordance with an exemplary embodiment;

FIG. 5 is a diagram of a communication network in accordance with yet another exemplary embodiment;

FIG. 6 is a flow diagram in accordance with a method of an exemplary embodiment;

FIG. 7 is a flow diagram in accordance with a method of an exemplary embodiment;

FIG. 8 is a diagram illustrating interaction between application in the network in accordance with an exemplary embodiment;

FIG. 9 is a diagram illustrating interaction between application in the network in accordance with an exemplary embodiment;

FIG. 10 is a diagram of a component of the communication network in accordance with an exemplary embodiment;

FIG. 11 is a diagram of a communication network in accordance with yet another exemplary embodiment;

FIG. 12 is a diagram illustrating interaction between application in the network in accordance with an exemplary embodiment;

FIG. 13 is a diagram illustrating interaction between application in the network in accordance with an exemplary embodiment;

FIG. 14 is a diagram of a communication network in accordance with yet another exemplary embodiment;

FIG. 15 is a diagram of a communication network in accordance with still another exemplary embodiment;

FIG. 16 is a diagram illustrating interaction between application in the network in accordance with an exemplary embodiment;

FIG. 17 is a diagram illustrating interaction between application in the network in accordance with an exemplary embodiment;

FIG. 18 is a diagram illustrating interaction between application in the network in accordance with an exemplary embodiment;

FIG. 19 is a diagram illustrating interaction between application in the network in accordance with an exemplary embodiment;

FIG. 20 is a diagram illustrating interaction between application in the network in accordance with an exemplary embodiment;

FIG. 21 is a diagram illustrating interaction between application in the network in accordance with an exemplary embodiment;

FIG. 22 is a diagram illustrating interaction between application in the network in accordance with an exemplary embodiment;

FIG. 23 is a diagram illustrating interaction between application in the network in accordance with an exemplary embodiment;

FIG. 24 is a diagram illustrating interaction between application in the network in accordance with an exemplary embodiment;

FIG. 25 is a diagram illustrating interaction between application in the network in accordance with an exemplary embodiment;

FIG. 26 is a diagram illustrating interaction between application in the network in accordance with an exemplary embodiment;

FIG. 27 is a diagram illustrating interaction between application in the network in accordance with an exemplary embodiment;

FIG. 28 is a diagram illustrating interaction between application in the network in accordance with an exemplary embodiment;

FIG. 29 is a diagram illustrating interaction between application in the network in accordance with an exemplary embodiment;

FIG. 30 is a diagram illustrating interaction between application in the network in accordance with an exemplary embodiment; and

FIG. 31 is a diagram illustrating interaction between application in the network in accordance with an exemplary embodiment.

### DETAILED DESCRIPTION OF THE EXEMPLARY EMBODIMENT(s)

Although the present invention will be described with reference to the exemplary embodiments shown in the drawings and described below, it should be understood that the present invention can be embodied in may alternate forms of embodiments.

An XML Message Bus (XBUS) is a transmission control protocol (TCP) based message exchange mechanism having a central TCP server. The XBUS may have many TCP clients called Bus Clients or XBUS Components (XComps). An XCOMP may be an NT Service, a GUI application or a windowless executable. These XCOMPs may be located on the same machine or can be distributed on other platforms across a network. There is complete freedom for the XCOMPs to be written in any language and run on any operating system as long as they can communicate via TCP and use XML messages that conform to the XBUS protocol. The XBUS transport layer may be accomplished via TCP socket connections where the XBUS is the Socket Server and all other components are Socket Clients (a.k.a. XBus Components or XCOMP). XCOMPs may be connected and disconnected at any time, although certain XCOMPs may stay connected on a long-term basis in order to provide services to other XCOMPs.

The XBUS may allow messaging to be directed between specific XCOMPs. The XBUS may also allow the XCOMPs the ability to subscribe to specific messages that are not sent to them directly. The latter can be used to broadcast event type messages that other XCOMPs can listen to without the need to know which XCOMPs are listening to the broadcast. The XBUS may be managed by an XBUS Service Manager (XSM) (not shown). The XSM may be an NT service that is used to manage the XBUS and the associated XCOMPs or components. In alternate embodiments, any suitable managing device or software may be used to manage the XBUS.

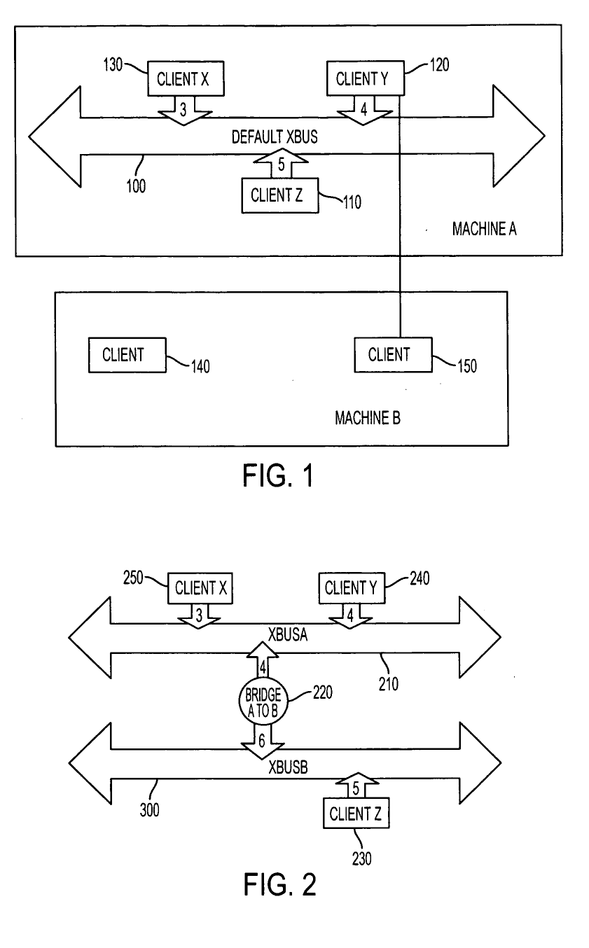

The XBUS communication network may have any suitable configuration. For example, in a single machine configuration (Machine A), as shown in FIG. 1, there may be only one XBUS 100 that serves several. XCOMPs 110, 120, 130. In this single machine configuration all the XCOMPs in the XBUS network are considered to be peers of one another. In alternate embodiments, the XBUS network may have a multi-machine configuration in which one XBUS, such as for example the XBUS 100 of Machine A, serves clients on several other machines such as for example, clients 140, 150 of Machine B.

In yet other alternate embodiments and as shown in FIG. 2, to facilitate larger XBUS networks an XBUS 200 can be bridged to another XBUS 210 through the use of an bridge 220. A bridge 220 may allow an XCOMP 230 connected to one XBUS 200 to communicate with an XCOMP 240, 250 that may be connected to a different XBUS 210. A bridge 220 may also control which messages are allowed to cross between XBUSes 200, 210. The main purpose of bridging XBUSes is to allow local traffic with higher message volume while providing the ability to bridge certain messages between buses. The XBUS network may be made of a variety of XCOMPs, such as for example, XCOMPs 230-250, that may be individual applications running on one or more machines. Each XCOMP only needs to connect to a central XBUS Server in order to communicate with any other XCOMP that is connected to the XBUS network.

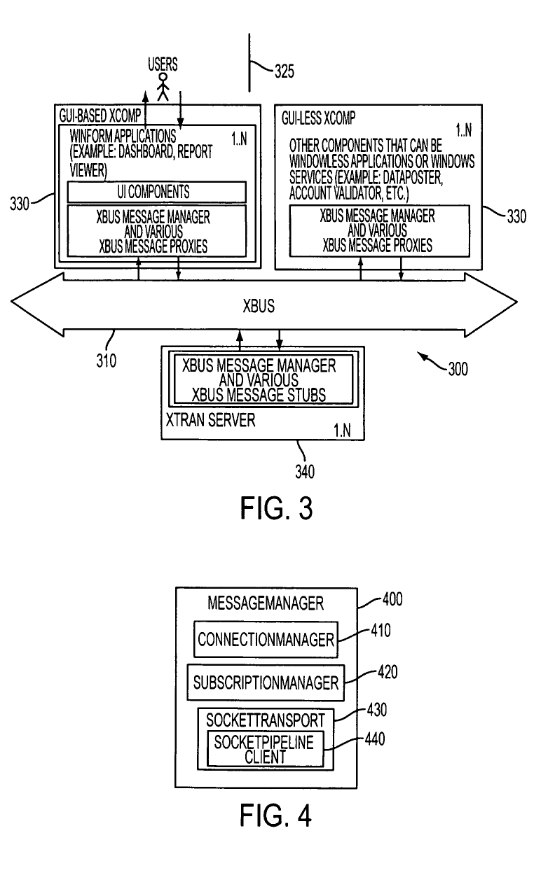

Referring now to FIG. 3, there are various types of XCOMPs that can be connected to the XBUS network. The three main categories of XCOMPs are: GUI-based XCOMPs, GUI-less XCOMPs and XTRAN Servers. When an XCOMP is connected to an XBUS, that XCOMP can communicate with any other XCOMP that is connected to the XBUS network. Any suitable type of XCOMP may be connected to the XBUS network 300 such as, for example, a graphical user interface (GUI) application 320 or a GUI-less application 330. An example of a GUI-less application would be a data poster whose job is to gather, for example, mailing machine data and send it to the XBUS without user intervention. The architecture of an XBUS network is extensible in that system components or XCOMPs can change without directly breaking the communication with other dependent components or XCOMPs in the system.

An XTRAN application or server 340 may also be connected to the XBUS network 300. XCOMPs that provide various services to other XCOMPs on the XBUS may be built upon XTRAN server functionality. An XTRAN Server 340 would be analogous to the server component in a traditional client server architecture. XTRAN servers are typically the targets of request messages that require some response. For example, a component whose purpose is to serve data to a report viewer XCOMP would be best implemented as an XTRAN Server. In the XBUS architecture the concept of a transaction server is not limited to database transactions, instead a transaction server is used to efficiently provide business services to the rest of the XBUS network. In fact the utilization of the XBUS allows for the creation of an XML based transaction server that can appropriately respond to the unsolicited messages it receives. The XTRAN server 340 is an XCOMP that hosts many message namespace stub objects for the purpose of efficiently processing request methods. Due to its multithreaded architecture, an XTRAN Server 340 may handle multiple simultaneous request messages. Also, an XTRAN server may handle request messages for multiple message namespaces.

An XTRAN Server uses the message stub classes (discussed below) that are created from the message schema in order to process request messages. With this flexibility, the same message stub class can be housed in a simple XCOMP or an XTRAN Server. Any XTRAN Server may be configurable as to which message namespaces they support as well as how many message stubs can be run simultaneously.

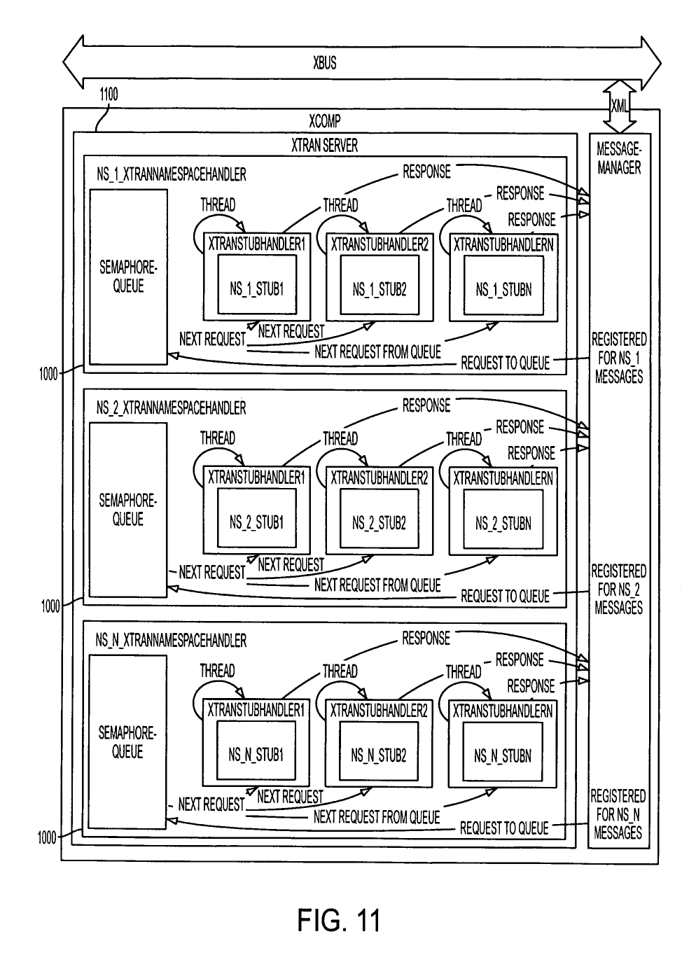

Referring now to FIG. 9, the hi-level component scheme that may comprise the general XTRAN architecture is shown. At a hi-level the architecture simply involves an XTRAN client 900 (which is really any XCOMP that can send request messages 920 to a given XTRAN server component) and an XTRAN server 910 which is capable of executing some transactions and optionally responding back 930 to the XCOMP that made the request.

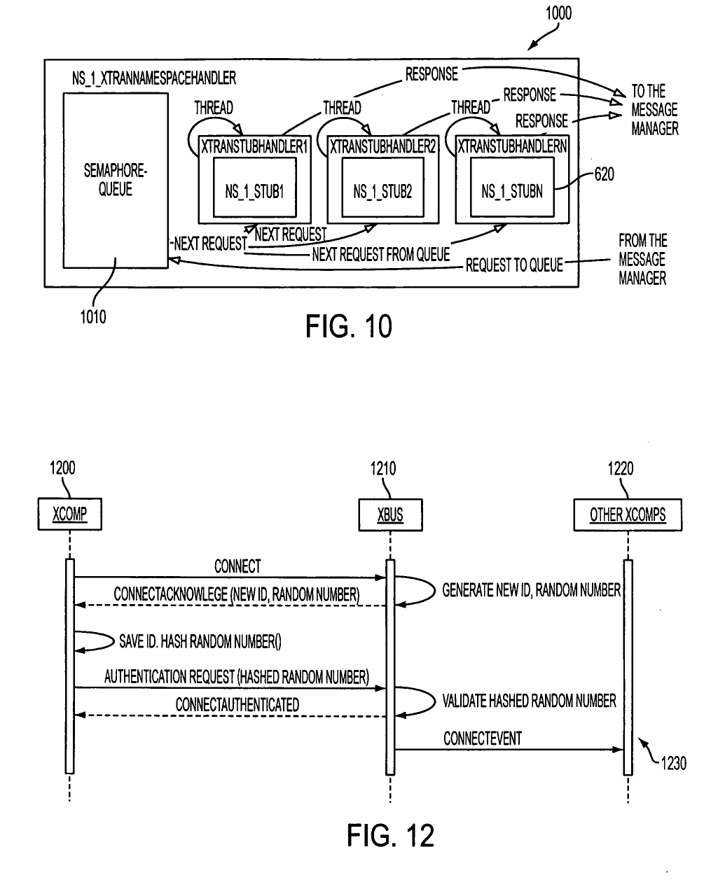

An XTRAN Server may own one or more XtranNamespaceHandlers. Each XtranNamespaceHandler 1000, as seen in FIG. 10, registers itself with the Message Manager to receive the messages for the namespace that it handles. As request messages are received, they are queued up in a SemaphoreQueue 1010.

The XtranNamespaceHandlers 1000 may be configured to have one to many XTranStubHandlers 1020, each of which may own a stub that handles messages for that namespace. Each of these XTranStubHandlers 1020 may be run on its own thread that wakes up as request messages are placed on the SemaphoreQueue 1010. As soon as a message stub finishes processing a request message its XTranStubHandler 1020 waits for the next unhandled request message to appear on the SemaphoreQueue 1010. As shown in FIG. 11, an XTRAN server 1100 may support one or more XtranNamespaceHandlers 1000.

The XTRAN Architecture is quite flexible in supporting a variety of “Transaction Server” models. The XTRAN architecture may support any desired feature including the following features which may be tailored appropriate to the desired “Transaction Server” application:

A single server entity that can support transactions for one or more Namespace Collections.

Namespace collections containing Namespace Stub instances which can be scaled according to appropriate metrics. An example of which would be a “Database Namespace Collection” containing a number of Stub Instances that correspond to the number of available database connections.

When an XCOMP is connected to the XBUS network, the XBUS may assign a unique connection ID that may identify that XCOMP to the network. It is this ID that may be used by a given XCOMP when it sends a message to identify itself as the sender. This ID may also be used by other XCOMPs to address an end point or recipient of a message. For communication in the XBUS network, the XBUS supports any suitable message type including for example, request messages, response messages, one-way messages and event messages. Request messages are sent directly from one XCOMP to request information from another XCOMP. Response messages are sent from the XCOMP that receives a request message back to the XCOMP that sent the request message. One-way messages are sent when a response is not required. This type of message can also be referred to as “fire and forget”. Event messages are broadcast messages that are sent by an XCOMP to notify other interested XCOMPs of some event that has occurred. The messages that travel along the XBUS network may be formatted to allow proper routing from one XCOMP to another. The message may include a header element and a body element that may aid the routing of the message.

The header element may contain information that may be used to route the message to a specific destination while the body element may contain the application specific message that is being routed. The header element may contain any suitable information that the XBUS uses to route messages from one XCOMP to another. The XBUS uses nested “Sender”, “Destination” and “Access” elements in order to perform this task.

The “Access” element is used to specify the potential reach of a message. This element can have one of three potential values:

Public—Public messages offer the greatest reach. Public messages, in addition to being routed to their specified destination, can also be subscribed to by other XCOMPs that are either connected to the same XBUS or an XBUS that is bridged to the sending XBUS. (Message Subscriptions will be discussed later in this document);

Local—Local messages are similar to Public messages with the restriction that they may not be propagated to connections on a bridged XBUS; or

Private—Private messages are only sent directly to the intended destination and cannot be seen by another XCOMP even if they have subscribed to receive that specific message.

The header element may also contain information about who sent the message (which is encapsulated in the nested “Sender” element) along with the intended destination of the message (which is encapsulated in the nested “Destination” element).

In addition to the “Sender”, “Destination” and “Access” elements, the header may also contain a nested “CorrelationID” element for Request and Response type messages. It is the “CorrelationID” that may be used to match a Request message with its corresponding Response message.

The element nested directly inside the body element may encapsulate the application specific message being sent. By convention, the name of this element is the name of the application specific message. Nested inside any application specific message element there may be 0 to N elements that represent the parameters of the message. Each of these parameter elements can further contain other arbitrarily nested elements. In alternate embodiments, the message may contain any suitable sections or elements.

It is the responsibility of the Message Manager object that is operating inside each XCOMP to manage the process of sending and receiving the XBUS messages across the XBUS network. The Message Manager is the component that handles the XCOMPs messaging and connection functionality as will be described below.

As shown in FIG. 4, the Message Manager 400 may include a connection manager 410, a subscription manager 420 and a socket transport 430. The socket transport 430 may have a socket pipeline client 440. The Message Manager 400 may be a singleton class that handles all of the messaging and connection functionality for an XCOMP. The Message Manager 400 may deal only at the XML level and it is up to the message proxy and message stub classes (described below) to convert these messages between their object and XML representation. The Message Manager 400 may be responsible for providing connection related functionality such as for example, connecting to the XBUS, disconnecting from the XBUS, notification of when another XCOMP is connected to the XBUS network and notification when another XCOMP is disconnected from the network. The Message Manager may also provide message registration functionality that allows Message Proxies and Stubs to register to receive messages for a specific message namespace, functionality that may allow both incoming and outgoing messages the ability to validate themselves against an XML schema and/or the ability to send an XML message via the XBUS to another XCOMP that does not require a response. A message proxy object may use the latter functionality when for example, sending a One Way XML message to a message stub that exists as part of another XCOMP. A message stub object may use the latter functionality when for example, sending an event notification XML message out to the XBUS network or sending a response XML message back to the requesting message proxy in another XCOMP.

The subscription manager 420 of the Message Manager may be responsible for managing the message subscription activities for a given XCOMP. The functionality provided by the subscription manager 420 may be the ability to subscribe to receive specific messages and/or message namespaces. After a subscription is made, the associated XCOMP may receive these messages even if this XCOMP is not the specified message destination. The functionality of the subscription manager 420 may also include the ability to remove a subscription that previously existed for this connection to the XBUS and or the ability to remove all subscriptions to which the XCOMP is currently subscribed.

The Subscription Manager 420 may maintain a local cache of the subscriptions that are associated with its connection to the XBUS. This may allow a subscription to be added or removed even if the XCOMP is not currently connected to the XBUS. Whenever the Message Manager 400 makes a successful connection to the XBUS, all of the subscriptions cached in the subscription manager 420 may be sent to the XBUS. While connected to the XBUS all new subscriptions are directly sent to the XBUS in addition to being cached locally. Whenever an XCOMP is disconnected from the XBUS, the XBUS itself may purge all subscriptions for that connection.

The connection manager 410 of the Message Manager 400 may handle the advertisement and dynamic connection discovery functionality of an XCOMP. When a XCOMP connects to the XBUS it may be assigned a numeric connection ID. Connection IDs may be assigned sequentially by the XBUS and are used to direct messages from one XCOMP to another. Because these connection IDs may be assigned on a first come first serve basis, it is impossible to assume that a specific XCOMP can always be addressed by a specific connection ID. This creates the need for all XCOMPs to have the ability to advertise the services they provide (if any) to the rest of the XCOMPs on the XBUS network. Having a connection manager 410 may make it possible for the XBUS network to implement plug and play functionality. The connection manager may send out an advertisement message that specifies all of the services that it provides (if any). This way any XCOMPs that are already online may be notified that an XCOMP has come online that provides a service that it can consume. The connection manager may also send out a service inquiry message to ask all other XCOMPs to advertise any services they provide. When the other XCOMPs receive this inquiry message, they may respond by sending out a message advertising their services. This advertisement may then be heard by the XCOMP that has just come online and may make note of any XCOMP that can provide the services that it consumes. This way the newly connected XCOMP may be aware of the services provided by other XCOMPs that are already online.

When specifying a provided service in an advertisement message, the message namespaces of the message stubs handled by a given XCOMP (which is more than likely an XTRAN Server) may be specified. The Connection manager 410 may be able to dynamically keep track of the services provided by it's XCOMP with the help of the Message Manager 400. When a message stub registers itself with the Message Manager 400 as a stub that handles a specific namespace, the Message Manager 400 may informs it's connection manager 410 of this namespace so that it may advertise this to the rest of the XBUS network.

The connection manager 410 may also able to dynamically determine the message namespaces of interest. These namespaces of interest correspond with the message namespaces associated with the message proxies that are used by the XCOMP. When a message proxy is registered with the Message Manager 400 as a proxy for a specific namespace, the Message Manager 400 may inform it's Connection manager 410 of this message namespace of interest. The Connection manager 410 may store a list of these namespaces of interest so that when it receives an advertisement message, it may determine if it should make note of the sender of the advertisement as providing a service that its XCOMP consumes. This cache of connections may be tracked by the namespace(s) to which they provide a message stub. The Connection manager 410 may also listen to disconnect event messages so that it can clean out any connections in the connection cache that have been disconnected. Because the cache of connections index by namespace is dynamically kept up to date, the Connection manager 410 is always immediately aware of the other XCOMPs on the XBUS that provide the services that it consumes.

The Connection manager 410 may provide functionalities such as for example, the ability to ask for a connection that handles a specific message namespace. Since the Connection manager 410 is always up to date, this information is readily available without the need to send any additional discovery messages on the XBUS. Because there exists the possibility that there is more than one XCOMP on the XBUS that provides a message stub for the specified namespace, the first connection that is found may be returned. The ability to ask for an array of connections that handle a specific message namespace may also be provided. The connection manager 410 may also provide an event that is fired or sent when an XCOMP is connected to the XBUS that provides a service of interest and/or an event that is fired when an XCOMP is disconnected that had provided a service of interest.

Although the Message Manager 400 may handle the XBUS messaging functionality for an XCOMP, it does not know the details of how the message is transported to the XBUS. The Message Manager 400 speaks to a generic message transport interface (not shown) which may handle transporting all of the XML messages to the XBUS. Although it may be possible for the Message Manager 400 to communicate with the XBUS through any class that implements the message transport interface, the default implementation is provided by the socket transport class. The socket transport class may use a socket pipeline client 440 class to make the actual TCP connection to the XBUS. The socket transport 430 may provide a XBUS specific implementation of the TCP socket connection to the XBUS.

Message namespaces may be used to give context to a given message name and may prevent problems associated with a message name being used for more than one function. Grouping messages into logical namespaces also helps to organize messages by the functionality they provide. There exists an XML Schema for every namespace of messages.

Using the standard XML namespace functionality, an “xmlns” attribute may be placed on the application specific message element (which may be nested inside the Body element of the message). It is the combination of the Message Name (as specified by the name of the application specific message element) with the Message Namespace (as specified by the “xmlns” attribute of the application specific message element) that makes a message unique.

In general, the XBUS itself does not concern itself with the purpose of a given message, it only needs to know the name and namespace of a message in order to be able to route a message to the proper destination(s). The only exception to this may be the messages in the “XBus” Message Namespace. This namespace may contain several messages that the XBUS itself produces or consumes in its normal processing.

As stated above, there is a group of XBUS messages that are directly used by the XBUS itself.

These messages are all included in the “XBus” message namespace. This namespace contains the following messages as shown in Table A:

TABLE A

| Message Name | Type | Description |
|---|---|---|
| ConnectEvent | Event | This message is sent from the XBUS to notify all |
| | | other interested |
| | | XCOMPs that a new XCOMP has just been connected |
| | | to the XBUS network. |
| ConnectAcknowledge | Event | This message is sent from the XBUS to an |
| | | XCOMP that has just connected to the XBUS |
| | | network. This message is used to acknowledge |
| | | that a connection has been made as |
| | | well as to give that newly connected |
| | | XCOMP some important information |
| | | regarding its connection. |
| AuthenticationRequest | Request | This message is sent from an XCOMP to the XBUS |
| | | in order to authenticate itself to the |
| | | XBUS as being an authorized Neopost |
| | | application. |
| ConnectAuthenticated | Response | This message is sent from the XBUS to an XCOMP to |
| | | confirm an authenticated connection. |
| DisconnectEvent | Event | This message is sent from the XBUS to notify all other |
| | | interested XCOMPs that an XCOMP has just |
| | | disconnected from the XBUS network. |
| Subscribe | Oneway | This message is sent from an XCOMP to the XBUS in |
| | | order to subscribe to receive messages |
| | | that they wish to listen in on. When an XCOMP |
| | | subscribes to a specific message, it may receive that |
| | | message even if it is not the specified |
| | | destination of that message (as long as the |
| | | message was not marked as “Private”). |
| Unsubscribe | OneWay | This message is sent by an XCOMP to the XBUS to remove |
| | | an existing subscription. |
| UnsubscribeAll | OneWay | This message is sent from an XCOMP to the XBUS as a |
| | | quick way to remove all of its current subscriptions. |
| GetSubscriptions | Request | This message is sent from an XCOMP to the XBUS to request |
| | | all of the current subscriptions. |
| GetSubscriptions | Response | This message is sent from the XBUS |
| Response | | back to the requesting XCOMP in response to the |
| | | GetSubscriptions request message. |

There are two other message namespaces that are defined at the generic XBUS level, these are the “XBus.Diagnostic” and “XBus.Services” namespaces.

Although these two message namespaces are not directly consumed by the XBUS itself, they do provide common functionality that is used by many of the XCOMPs on the XBUS network.

“XBus.Diagnostic” message namespace contains messages that can be used as a tool to perform diagnostic operations across the XBUS network. This message namespace contains the following messages as shown in Table B:

TABLE B

| Message Name | Type | Description |
|---|---|---|
| StartTimerEvent | Event | This message is broadcast from one |
| | | XCOMP to notify other XCOMPs to start |
| | | a local timer. This message can be |
| | | used to diagnose performance issues |
| | | across XCOMPs. |
| StopTimerEvent | Event | This message is broadcast from one |
| | | XCOMP to notify other XCOMPs to stop a |
| | | local timer. This message can be used |
| | | to diagnose performance issues across |
| | | XCOMPs. |

The “XBus.Services” message namespace provides messages that enable the dynamic discovery of other XBUS components that are connected to the XBUS network based on the message namespaces that they support. This message namespace contains the following messages as shown in Table C:

TABLE C

| Message Name | Type | Description |
|---|---|---|
| ServiceAdvertisementEvent | Event | This message is broadcast |
| | | from an XCOMP to notify |
| | | other XCOMPs about the |
| | | message namespaces that it |
| | | handles. After an XCOMP |
| | | successfully connects to |
| | | the XBUS it may send this |
| | | service advertisement |
| | | message. |
| ServiceInquiryEvent | Event | This message is broadcast |
| | | from an XCOMP to request |
| | | that all other XCOMPs on |
| | | the XBUS network advertise |
| | | the message namespaces that |
| | | they serve. When an XCOMP |
| | | receives this notification, |
| | | it may immediately respond |
| | | by sending a |
| | | ServiceAdvertisementEvent |
| | | message. After an XCOMP |
| | | successfully connects to |
| | | the XBUS and advertises the |
| | | services it provides, it |
| | | may send this message. |

As noted above, an XML Schema may exist for each namespace of messages. Each XML Schema may contain definitions for the application specific messages along with all of the parameter elements for those messages. These schemas may serve to validate messages sent on the XBUS network and to generate code that may provide an object-oriented implementation that can be used to more easily communicate on the XBUS.

The XBUS makes it possible for XCOMPs to subscribe to messages of interest for which they are not the specified recipient. This functionality is especially useful when an XCOMP wants to receive a broadcast notification message that is sent from another XCOMP. An example of this would be when an XCOMP broadcasts a Service Inquiry Event message. The XCOMP that broadcasts this message across the XBUS may directly know about the other connected XCOMPs. It is up to the other XCOMPs to subscribe to this message in order to receive it.

The Subscriptions for any given XCOMP are managed at the XCOMP using a Subscription Manager. The Subscription Manager 420 (which is owned by the Message Manager 400) is the class that is responsible for sending the appropriate messages to the XBUS to manage the process of subscribing and unsubscribing to messages. The Subscription Manager 420 is discussed in more detail below.

For any given XCOMP to subscribe to a specific message of interest, it may send a “Subscribe” message (from the “XBus” message namespace) to the XBUS itself. This subscription message may contain information about the specific messages or message namespaces to which the XCOMP is subscribing. When the XBUS receives this subscription message, it may note in a subscription registration lookup table that the calling XCOMP wishes to receive messages of the specified type even if the message is not addressed to that XCOMP. That way, when the XBUS receives a message of that type it may forward it onto all of the XCOMPs that have subscribed to this message after it has sent the message to the specified destination. If a subscribe message is received by the XBUS that contains a subscription that is already in place, that subscription message may be ignored.

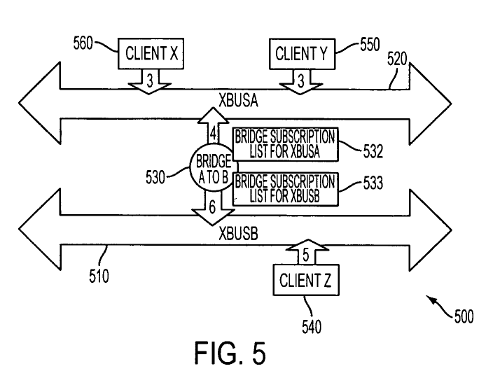

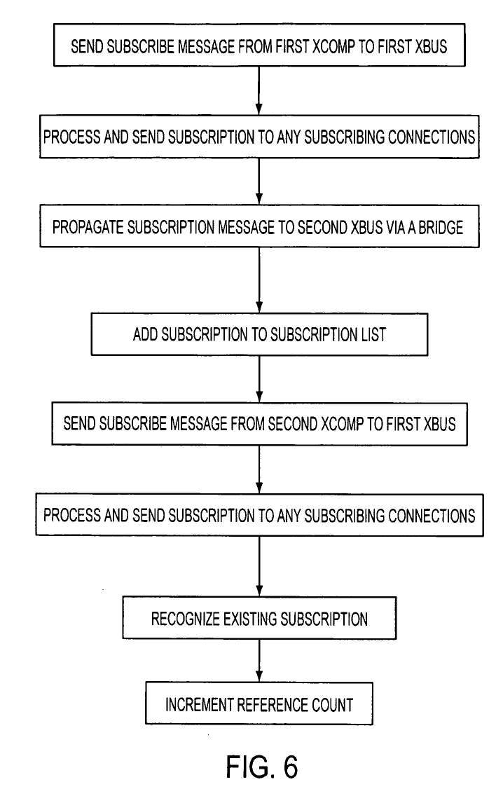

Referring to FIGS. 5 and 6, a method for subscribing to a message in a bridged XBUS network 500 will now be described. Although this method is for a bridged XBUS network, it will be appreciated that this method can also be applied to a non-bridged XBUS network such as that shown in FIG. 1. When XCOMP 560 subscribes to a message, for example message “ABC”, it may send a subscribe message to its XBUS 520 (Block 600). When XBUS 520 receives the subscribe message, it processes the subscription and sends that same subscription message out to any connections that have subscribed to the subscribe message (Block 610). Since all bridges subscribe to the subscription messages that occur on both XBUSes 510, 520 that it connects, the bridge 530 receives the subscribe message. Bridge 530 propagates the subscription message to XBUS 510 (Block 620). In addition to propagating the subscription message to XBUS 510, bridge 530 adds the subscription into the bridge subscription list 533 for XBUS 510 (Block 630). XCOMP 550 may also send a second subscribe message for message “ABC” to XBUS 520 (Block 640). In this case XBUS 520 may process the second subscription and pass the subscribe message into bridge 530 (Block 650). When bridge 530 receives the second subscribe message it may recognize that a subscription already exists for this message on XBUS 510 (Block 660). Instead of passing the subscribe message through to XBUS 510, bridge 530 may increment a reference count for that subscription in the bridge subscription list 533 (Block 670).

An XCOMP may also unsubscribe to messages when they are no longer of interest to that specific XCOMP. Doing this decreases traffic on the XBUS network for messages that would otherwise be ignored. Once an XCOMP has unsubscribed to a specific message or namespace of messages, they may no longer receive those messages unless they are the specified destination. The Unsubscribe message (which also lives in the XBus message namespace) works in a substantially similar manner as the Subscribe message described above. For convenience, there may be an Unsubscribe All message that exists in the XBUS message namespace that may provide a quick way to remove all subscriptions for a given XCOMP.

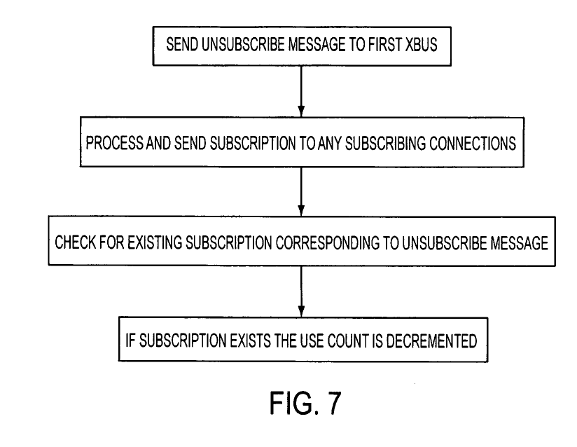

Referring to FIGS. 5 and 7 a method for unsubscribing to a message will now be described. Continuing with the above subscription example, XCOMP 550 on XBUS 520 may no longer want to receive “ABC”]messages, as subscribed to above. XCOMP 550 may send an unsubscribe message to XBUS 520 (Block 700). XBUS 520 may again pass the message to bridge 530 (Block 710). When bridge 530 receives the message, it checks to see if the subscription to “ABC” exists in the bridge subscription list 533 (Block 720). If the subscription exists in list 533 it may decrement its use count (Block 730). For example, because both XCOMP 560 and 550 subscribed to message “ABC” the use count would now equal one. If the use count was decremented to zero, that entry or subscription would be removed from the list 533 and the unsubscribe message would be propagated to the other side of the bridge 530 which would send an unsubscribe message for “ABC” to XBUS 510.

In alternate embodiments, whenever a connection is disconnected from the XBUS, either intentionally or unintentionally, the XBUS may remove any subscriptions associated with the XCOMP that was just disconnected. As part of this process, the XBUS may manufacture and broadcast an unsubscribe message to all interested XCOMPS. Doing this may allow the bridges to properly propagate the unsubscribe across the connected XBUSes.

In order for an XCOMP to subscribe or unsubscribe to a message, the XBUS architecture provides a dynamic network that may implement plug and play functionality to allow XCOMPs to immediately discover other XCOMPs that may provide a desired functionality as they are connected and disconnected from the XBUS network. To provide this type of functionality an XCOMP may be able to advertise the message namespaces that they service when connected to the XBUS. This may make it possible for other connected XCOMPs to know about another newly connected XCOMPs that may be providing a desired service. An XCOMP may be able to request all other connected XCOMPs to advertise the namespaces they service as they themselves become connected to the XBUS. This may allow a newly connected XCOMP to discover the services that other connected XCOMPs provide. An XCOMP may keep a list of other XCOMPs that provide services for the message namespaces that it consumes or desires. This list may be dynamically updated as XCOMPs are connected and disconnected from the XBUS. This component discovery mechanism is implemented by a Connection Manager 410 object that is contained by the Message Manager 400 of each XCOMP in the XBUS network. The Connection Manager 410 is discussed in more detail below.

Because the XBUS network utilizes XML messages as its communication protocol each XCOMP may parse these XML messages to get at the application specific message content. Rather then making each XCOMP manually parse and create these XML messages, an Object Oriented interface to the XBUS network may be implemented. In alternate embodiments any suitable interface may be implemented. Using the object form of these messages essentially allows an XCOMP to make RPC type method calls across the XBUS network.

To facilitate this object interface into the XBUS messaging network, a message proxy and message stub is created for each XBUS message namespace. It is the message proxy that may be used by an XCOMP that wishes to send request messages to other XCOMPs. The message stub that may be used by an XCOMP to provide the actual functionality for the messages of a given message namespace. The proxy and stub classes may be responsible for serializing the message object into its XML form and de-serializing XML messages into their message object form.

Any given message proxy or message stub can become quite complex especially for message namespaces that contain lots of messages. Since hand coding these proxy and stub classes can become very error prone, a proxy/stub code generator may generate these classes from a message namespace XML schema. Code generation of these classes will be discussed below.

A message proxy class may exist for each namespace of messages. It is the message proxy that allows an XCOMP to call methods implemented in another XCOMP on the XBUS network. The message proxy also fires or sends events in response to notification messages sent from another XCOMP. This class may inherit from a standard base class (Client Protocol) to provide an object-oriented proxy to XML functionality that is specific to that message namespace. A message proxy may contain for example, a .NET event that may handle each event message defined in the message namespace schema. A message proxy may also contain a method for each request message defined in the message namespace schema. These methods may have parameter objects that map to the child elements of the message as defined in the schema and may return an object that maps to the contents of the response message associated with that request. These methods may allow the user 325 (FIG. 3) to make a synchronous request method call that may map to an inherently asynchronous request/response messaging operation. A method for each one way (“Fire and Forget”) message defined in the message namespace schema may also be contained in the message proxy. Since these methods do not have a return value, they can create and send the corresponding XML message without waiting for a reply. NET events may also be created for all request/response and one way messages defined in the message namespace schema in addition to the event messages. This may be done to make it easy for XCOMPs to listen-in on specific messages sent on the XBUS to which they are not the specified destination. In alternate embodiments, the message proxy may contain any suitable or desired information.

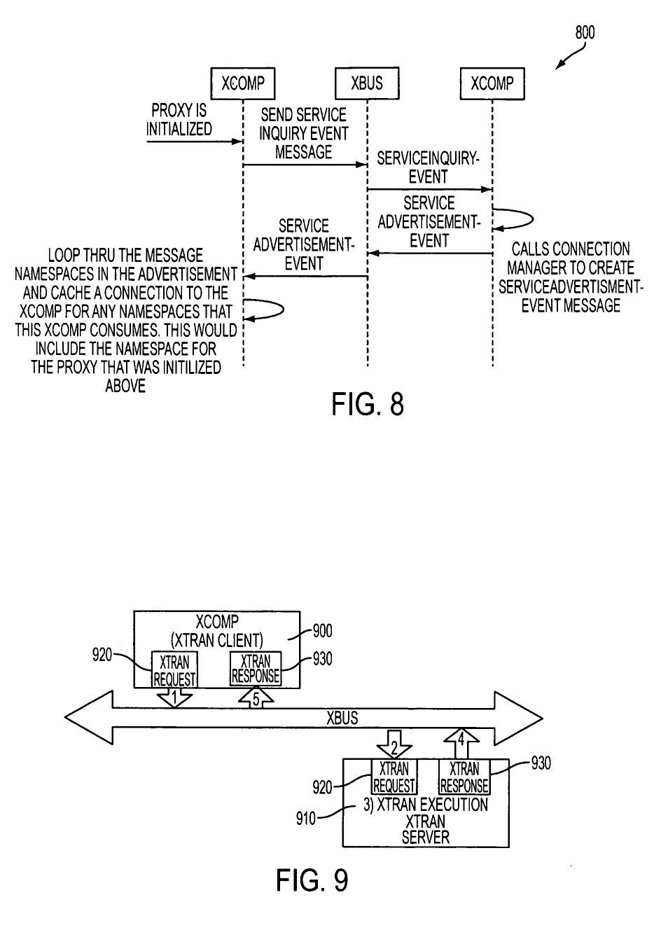

As can be seen in FIG. 8, each message proxy class may also contain any suitable code used to plug itself into the XBUS messaging infrastructure 800. This functionality may include for example, connecting the message proxy to the Message Manager for the purpose of sending request messages, receiving response messages and receiving event messages. In alternate embodiments, each message proxy may include code to automatically subscribe or unsubscribe to event messages or methods to dynamically fire or send an appropriate event associated with a received event message.

A message stub class may also exist for each message namespace. A message stub may provide the actual implementation for a method that is called by the message proxy of some other XCOMP on the XBUS network. The message stubs may inherit from a standard base class (Server Protocol) that provides much of the generic functionality necessary to call the specific method associated with a request or one way message. A message stub may contain for example, a method for each request message defined in the message namespace schema. Each of these methods may contain a parameter list that maps to the child elements of the message as defined in the schema. Also, these methods may have a return type that may be serialized into XML and sent back to the calling XCOMP. This method is called by the underlying base class when a request message for this method is received from the XBUS. The message stub may also contain a method for each one way (“Fire and Forget”) message defined in the message namespace schema. Like the methods that handle request messages, these one way methods may contain a parameter list that may map to the child elements of the message as defined in the schema. Unlike the request methods, these one way methods do not have a return type. A method for each event message defined in the message namespace schema that may facilitate sending an event notification message to other interested XCOMPs may also be contained in the message stub. In alternate embodiments, any suitable or desired information may be contained in the message stub.

Each message stub class may also contain any suitable code used to plug itself into the XBUS messaging infrastructure. This functionality may include for example, connecting the message stub to the Message Manager 400 for the purposes of responding to request messages, handling one way messages and firing event messages and methods used by the underlying base class that are used to dynamically invoke the request and one way methods implemented by the message stub.

The proxy and stub classes along with the message classes themselves for a given message namespace may be generated using the XML message namespace schema which may completely specify the messages for a given message namespace.

Before generating the proxy and stub classes, the classes that encapsulate the messages themselves may be created. NET classes may be generated that can be easily serialized and deserialized to and from XML. These objects are used to both convert the XML messages into object form when a message is received as well as convert a message object into XML when a message is sent.

For any given message namespace XML Schema, a single file may be generated that may include classes for all of the complex and simple types that are defined in the message namespace schema. These classes may be tagged with NET attributes that provide assistance when serializing and deserializing these objects between their object and XML representation. Once the message classes have been generated from the message namespace XML schema, proxy and stub classes can be generated that may make extensive use of the previously generated message classes.

To start and configure a local XBUS network, which may have one or more XBUSes that may or may not be bridged together (as will be described below), the XMS first starts the XBUS application and then the other applications attached to it. As each application is started it may be passed command line arguments with information as to how they are to attach to the XBUS. The XSM uses an XML configuration file to start the XBUS(es) and attach the other components to the XBUS(es). The configuration file may contain records which identify the components, such as for example, connection Ids, to be started and the command line arguments to be passed to them. In alternate embodiments the configuration file may contain any desired information or commands. Since the XBUS components or XCOMPs may span multiple machines, an XSM may exist on each machine that hosts an XCOMP on the XBUS network. Each of these XSMs may be responsible for launching the XCOMPs on that machine.

The XSM may also be responsible for stopping all the XBUS components either when the system is shutting down or when a user action mandates it, such as for example when maintenance operations or software updates are desired. To shutdown the XBUS system the XSM may send a prepare to shutdown notification to the XBUS. All XCOMPs running on the XBUS may receive this notification and place themselves in a quiescent state. The XCOMPs send a ready to shut down message back to the XBUS. The XSM sends a shutdown message to the XBUS and all XCOMPs are disconnected from the XBUS and shutdown. Thew XSM sends an XBUS Shutdown message and the XBUS then terminates.

The XSM may also keep track of the health of the XBUS as well as the components or XCOMPs attached to it. This may be done by the use of watchdog messages being sent by all components at an interval whose value is passed to the components when they are started. Each of the components sends an “alive” message onto the XBUS on an interval that is based on the base time interval that is passed in to each component plus a randomized time increment that may be between zero and two seconds. In alternate embodiments any suitable time increment may be used. The random component may be to prevent all of the “alive” messages from coming at the same time. If the XSM does not receive the “alive” message within the allowable window of time, then it logs an alarm message to that effect and sends a notification message to the XBUS to allow user applications to display the warning to the user. Although XBUS networks whose XBUS Components (XCOMPs) span more than one machine may have a XSM that exists on each machine that hosts an XCOMP, only one of those XSMs may handle the integrity monitoring for the XBUS network. In alternate embodiments the integrity of the network may be managed by any suitable number of XSMs or by any other suitable method, device or software means.

When an XCOMP starts up, it may first attempt to connect itself up to the XBUS. Information about where the XBUS server is on the network can be either in the NET application configuration file that is associated with the executable or can be passed in on the command line. The process of connecting to the XBUS can be seen in FIG. 12 and is as follows:

The XCOMP 1200 may call the Connect method on the Message Manager 400. The Message Manager 400 may in turn call the Connect method on its IMessageTransport interface. The Socket Transport class (which is the default implementation of the IMessageTransport interface) may then inform its Socket Pipeline Client 440 object to make a TCP Socket Client connection to the XBUS (which is acting as a TCP Socket Server).

After the XCOMP 1200 makes a TCP socket client connection to the XBUS 1210, the XBUS 1210 may assign a connection ID to that connection. These connection IDs are assigned by the XBUS 1210 in sequential order. At this point the XBUS 1210 may send the newly connected XCOMP 1220 a ConnectAcknowledge message that may contain the connection ID that it was assigned along with a random number. The random number that is sent may be used as part of a handshake that XCOMP 1200 may need to complete to authenticate itself as an approved XCOMP. The XBUS 1210 may now hold this connection in limbo and expects that the next message it receives from that XCOMP 1200 may be to complete the handshake. If it receives any other message or an improper handshake, the XBUS 1210 may immediately disconnect the XCOMP 1200 from the XBUS Network 1230. This handshake may provide some measure of revenue protection as it guards against unauthorized XCOMPs to be granted access to the XBUS network 1230. The handshake also allows the XBUS network 1230 to be thought of as a trusted network.

When the XCOMP 1200 receives the ConnectAcknowledge message it may save its Connection ID to what was sent in the message. In addition, the XCOMP 1200 may also take the sent random number and transform that number using a proprietary algorithm. The XCOMP 1200 may then populate the AuthenticationRequest message with the transformed number and send it back to the XBUS 1210.

Upon receiving the AuthenticationRequest message, the XBUS 1210 may examine the transformed number that was passed in the message and verify that it is correct. If it is not correct, the XBUS 1210 may immediately disconnect the XCOMP 1200 from the XBUS network 1230. If the key is correct, the XBUS 1210 may send back a ConnectAuthenticated message.

When the XCOMP 1200 receives the ConnectAuthenticated message from the XBUS 1210 it considers itself fully connected and may be able to send and receive messages.

It is possible that the XCOMPs that make up the XBUS network may be spread out across many machines. This means that the stability of the TCP Socket connections is at the mercy of the stability of the local network making it quite possible that any given XCOMP could lose its connection to the XBUS at any time. Since many of these XCOMPs have no user interface, there needs to be a way to automatically heal a broken connection without any user intervention.

To accomplish this, all XCOMPs have a mechanism by which, once disconnected they may continuously try to reconnect back to the XBUS. The mechanism may be triggered by the Message Manager 400 which fires an event when the XCOMP becomes disconnected. The handler for this event may start a separate thread that may continue to attempt to reconnect until a valid connection is made.

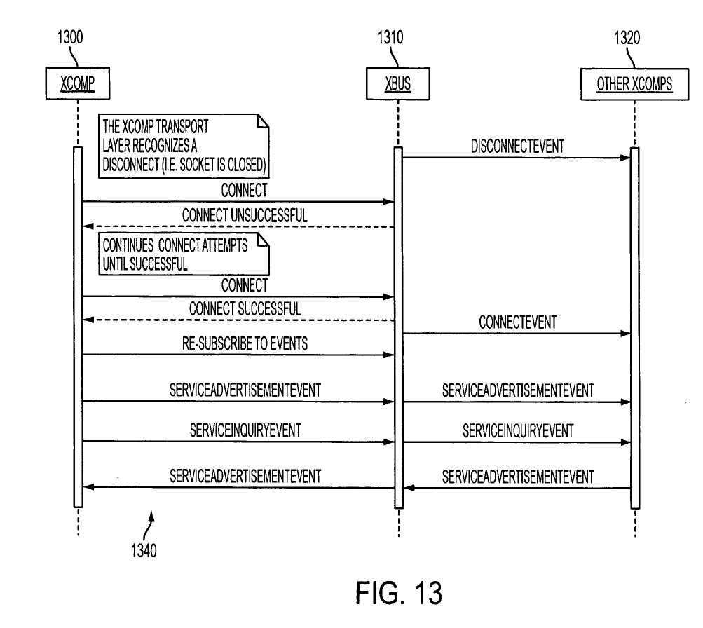

There are many things that may be orchestrated in order for this auto reconnect process to function seamlessly across the XBUS network. As can be seen in FIG. 13, the following is a high level description of what is happening through this process.

When an XCOMP 1300 becomes disconnected from the XBUS 1310, the XBUS 1310 may remove all of the subscriptions for that connection from its subscription table and send out a DisconnectEvent message to notify all other XCOMPs 1320 that this XCOMP 1300 has been disconnected. When other XCOMPs 1320 in the XBUS network 1340 receive this DisconnectEvent, they may inform the Connection Manager to remove any cached connections to the XCOMP 1300 that was just disconnected. The Connection Manager may also fire a ServiceDisconnect event so that any functionality that is associated with the disconnected XCOMP 1300 may immediately deal with the consequences of this situation.

When the XCOMP 1300 realizes it no longer has a connection to the XBUS 1310, the Message Manager may fire a Disconnect event that indicates that this XCOMP 1300 has been disconnected. This event may be handled in the XCOMP 1300 by starting a separate thread that may continuously try to reconnect to the XBUS 1310 until a new connection is made. When successfully reconnected, the XCOMP 1300 is assigned a new connection ID. At this point the newly connected XCOMP 1300 may tell the Subscription Manager to send a Subscribe message for all of the subscriptions that it contains. Even though the XBUS 1310 removed all of this XCOMP's 1300 subscriptions when it was disconnected, the local Subscription Manager still maintained all of the subscriptions that were made so that it could re-subscribe to those message when it comes back online. Of course when the Subscription Manager re-subscribes it may do so with its newly assigned connection ID. The XCOMP 1300 may tell the Connection Manager to send a new ServiceAdvertisementEvent out to the XBUS network 1340. This may alert other XCOMPs 1320 of the services offered by this XCOMP 1300 along with its new connection ID. The XCOMP 1300 may also tell the Connection Manager to send a ServiceInquiryEvent message out to the XBUS 1310 so that other XCOMPs 1320 on the XBUS network 1340 can inform this XCOMP 1300 about services they provide. This is important because these connections may have changed while this XCOMP was disconnected. Upon receiving the ServiceAdvertisementEvent message from the newly connected XCOMP 1300, the other XCOMPs 1320 may now be able to recognize this reconnected XCOMP 1300 with its new connection ID.

All XCOMPs in the XBUS network may be configured so that, at a minimum, they know how to reach the XBUS to which they should connect. In addition to this connection information, many XCOMPs can also be configured in other ways even down to specifying much of the Message Manager details. Much of the configuration may be designated in a NET application configuration file as well as being passed in on the command line. Whenever a specific configuration setting is set in both the configuration file and in a command line argument, it may be the command line argument that takes precedence.

The Message Manager has many configuration options. If this configuration information is not provided, default configuration information may be used. This way, this information only needs to be provided when the default behavior is not acceptable.

The MessageManagerSettings may be part of a custom NET configuration handler that may know how to properly parse all of the Message Manager configuration information.

The configuration elements that may be nested inside the MessageManagersettings element may be used to configure the various components that make up the Message Manager. These nested configuration elements are as follows shown in Table D.

TABLE D

| | |
|---|---|
| MessageManagerInfo | This section is responsible for the |
| | settings that pertain to the Message |
| | Manager itself. |
| MessageTransportInfo | This section is responsible for |
| | creating and initializing the component |
| | that may implement the |
| | IMessageTransport interface that the |
| | Message Manager may use to communicate |
| | with the XBUS. |
| ConnectionManagerInfo | This section is responsible for |
| | creating and initializing the component |
| | that may implement the |
| | IConnectionManager interface that the |
| | Message Manager may use for the purpose |
| | of auto-discovery of other XCOMPs. |
| SubscriptionManagerInfo | This section is responsible for |
| | creating and initializing the component |
| | that may implement the |
| | ISubscriptionManager interface that the |
| | Message Manager may use for handling |
| | the messages subscriptions required by |
| | this XCOMP. |

Table E explains the attributes of the MessageManagerInfo configuration element:

TABLE E
MessageManagerInfo

| | |
|---|---|
| ResponseWaitTime | The number is milliseconds to wait to receive a |
| | response message to a pending request message. |
| | (Default: 5000 ms) |
| ValidateRequests | Whether to validate the XML request messages against |
| | the associated XML Schema. (Default: false) |
| ValidateResponses | Whether to validate the XML response messages against |
| | the associated XML Schema. (Default: false) |
| ValidateUnsolicited | Whether to validate all unsolicited XML messages |
| | (event notification messages) against the |
| | associated XML Schema. (Default: false) |
| RequestMessageSemaphoreCount | This controls the number of thread pool threads that |
| | can be used at any given time to handle request |
| | messages that are to be processed. (Default: 5) |
| UnsolicitedMessageSemaphoreCount | This controls the number of thread pool threads that |
| | can be used at any given time to handle |
| | unsolicited message (event notifications) |
| | that are to be processed. |
| | (Default: 5) |

The MessageTransportInfo element allows the application to specify the class that may implement the IMessageTransport interface as well as some other settings. By default, the SocketTransport class in the MTI.XBus.dll is used to implement the IMessageTransport interface. Table F explains the attributes of the MessageTransportInfo configuration element:

TABLE F
MessageTransportInfo

| AssemblyName | The assembly name that holds the class that |
|---|---|
| | may implement the IMessageTransport |
| | interface. |
| ClassName | The class name in the above assembly that |
| | may implement the IMessageTransport |
| | interface. |
| ConnectionString | The connection string to use when |
| | connecting to the XBus. The format of this |
| | string is dependent on the transport. In |
| | the default case, where the SocketTransport |
| | class is used, this connection string is in |
| | the following format: |
| | <HostName>:<PortNumber>. (Default: “:7000” |
| | which specifies the local host at port |
| | 7000) |
| ConnectTimeout | The number of milliseconds to wait for the |
| | connection process to complete. (Default: |
| | 15000) |

The ConnectionManagerInfo element allows the application to specify the class that may implement the IConnectionManager interface. By default, the Connection Manager class in the MTI.XBus.dll is used to implement the IConnectionManager interface. Table G explains the attributes of the ConnectionManagerInfo configuration element:

TABLE G
ConnectionManagerInfo

| | |
|---|---|
| AssemblyName | The assembly name that holds the class that |
| | may implement the IConnectionManager |
| | interface. |
| ClassName | The class name in the above assembly that |
| | may implement the IConnectionManager |
| | interface. |

There may be an optional “ServicesProvided” element that can be nested inside the ConnectionManagerInfo element. This element may specify message namespaces that should be advertised for this connection. Under normal circumstances, when a message stub is initialized, its namespace is automatically added to the namespaces that are advertised for this connection. This element is only needed in cases where a service is advertised that is implemented directly with XML and does not make use of a message stub. In this element there may be a nested “MsgNamespaces” element that may specify these namespaces. The “MsgNamespaces” element can contain one to many “MsgNamespace” elements that may contain the name of the message namespace.

There may also be an options “ServicesConsumed” element that can also be nested inside the ConnectionManagerInfo element. This element can specify message namespaces that this XCOMP consumes and needs to know about. Under normal circumstances, when a message proxy is initialized, its namespace is automatically added to the message namespaces consumed. This element may be used in cases where a service is consumed directly with XML and do not use a message proxy. In this element there is a nested “MsgNamespaces” element that may specify these namespaces. The “MsgNamespaces” element can contain one to many “MsgNamespace” elements that may contain the name of the message namespace.

The SubscriptionManagerInfo element may allow the application to specify the class that may implement the ISubscriptionManager interface. By default, the ISubscriptionManager interface may be implemented by the Subscription Manager class in the MTI.XBus.dll. Table H explains the attributes of the SubscriptionManagerInfo configuration element.

TABLE H
SubscriptionManagerInfo

| | |
|---|---|
| AssemblyName | The assembly name that holds the class that |
| | may implement the ISubscripitonManager |
| | interface. |
| ClassName | The class name in the above assembly that |
| | may implement the ISubscriptionManager |
| | interface. |

Nested inside the SubscriptionManagerInfo element are the “LocalSubscriptionConfig” and the “DefaultSubscriptions” elements. Both of these elements may contain a “Subscriptions” element (which is the same element that is used inside the subscription messages themselves).

The “LocalSubscriptionConfig” element may be used to specify the message namespaces that may be considered to be “Local Subscriptions”. “Local Subscriptions” may be for messages that originate on the same bus. When a subscription message is about to be sent, these “Local Subscriptions” are checked to see if the subscription message should span to other bridged XBuses. Any namespace not included as a “Local Subscription” may be considered to be a public subscription. This element may be optional.

The “DefaultSubscriptions” element may be used to specify subscriptions that a given XCOMP may always be subscribed to. Under normal operation, this element is not needed. Subscriptions may be for unsolicited event type messages, which are represented in a message proxy as a NET event. When an event handler is connected to the generated NET event, the generated proxy class automatically subscribes to that specific message. Likewise, a message is unsubscribed by removing the event handler from the generated NET event. Since more than one event handler can be connected to a single NET event, the Subscription Manager may internally reference count the subscriptions and only send the appropriate “Subscribe” or “Unsubscribe” message when necessary.

The XTranServerSettings are part of a custom .NET configuration handler that knows how to properly parse all of the XTran Server configuration information.

The “XTranServerSettings” element contains one to many “NamespaceHandlerInfo” sections. There exists a nested “NamespaceHandlerInfo” section for each message namespace that the XTran Server may handle. The “NamespaceHandlerInfo” element contains the following attributes and nested element as shown in TABLE I.

TABLE I
NamespaceHandlerInfo

| | |
|---|---|
| AssemblyName | The assembly name that holds the class |
| | that may implement the IMessageHandler |
| | interface for the message stub that may |
| | be supported. |
| ClassName | The class name in the above assembly |
| | that may implement the IMessageHandler |
| | interface for the message stub that may |
| | be supported. |
| Nested “Instances” | Specifies the number of stub handlers |
| element | that may service the incoming messages |

In addition to many of the configuration file settings, there may also exist many command line arguments that can be used when launching an XCOMP or the XBUS itself. These command line arguments may take precedence over any setting that may also exist in the configuration file. Table J are the general command line arguments that can be used when launching any XCOMP (or XBUS).

TABLE J
Command Line Arguments

| | |
|---|---|
| /XBUSIP | The IP address or host name of |
| | the XBUS. |
| /XBUSPort | The socket port number that the |
| | XBUS is listening on. |
| /InstanceName | The name of the XCOMP or XBUS. |
| | This may allow a distinct name |
| | to be given to any component on |
| | the XBUS including the XBUS |
| | server itself. |
| /WDogPeriod | The interval in seconds that an |
| | XCOMP should send out a watch |
| | dog message. The watch dog |
| | messages are used to determine |
| | the health of a component on |
| | the XBUS. |
| /T1 | Log level 1 trace event to the |
| | event logger |
| /T2 | Log level 2 trace event to the |
| | event logger |
| /T3 | Log level 3 trace event to the |
| | event logger |
| /T4 | Log level 4 trace event to the |
| | event logger |
| /T5 | Log level 5 trace event to the |
| | event logger |

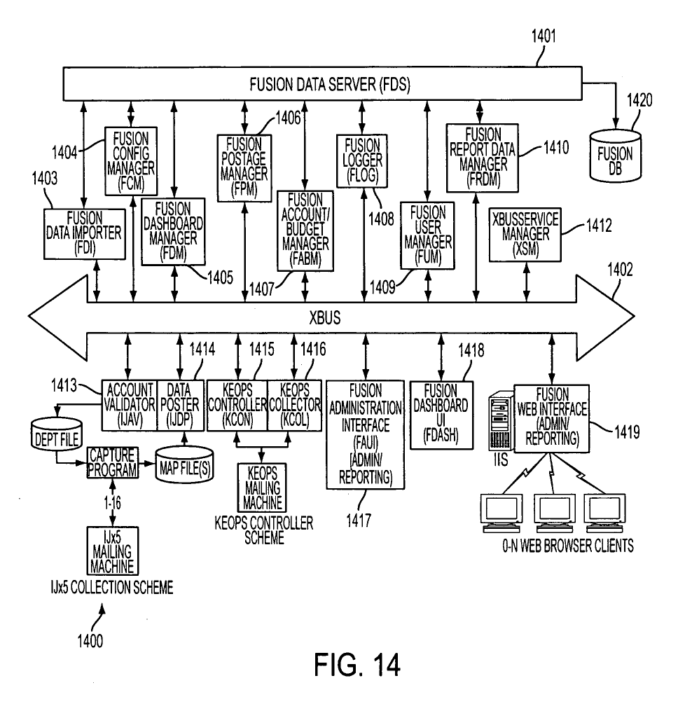

The architectural diagram of FIG. 14 shows all of the XCOMPs that are part of the Fusion system 1400. As discussed previously, an XCOMP is an XBUS component that is connected to the XBUS as a TCP Socket Client and participates in XBUS Messaging. The XCOMPs depicted above the XBUS provide services to the XBUS network while the XCOMPs depicted below the XBUS consume these services.

All Fusion components are based on the XBUS XCOMP and XTRAN foundation which handles most of the functionality for dealing with the XBUS 1402. The Fusion Data Server 1401 may be the only exception. It may be implemented not as an XCOMP 1403-1419, but as a collection of NET remote objects. There are four basic types of components used in Fusion, the GUI-Based XCOMPs, GUI-less XCOMPs, XTRAN Server XCOMPs and the Fusion Data Server (FDS). The first three types have been explained in the previous section and are aspects of the XBUS architecture. The Fusion Data Server 1401 is unique to the Fusion system.

This server exposes NET remote objects that can be used by other components to access the database. The Fusion Data Server 1401 may be implemented in this way primarily to be able to consolidate all of the connections to the database in one place so as not to inadvertently run out of database connections. It is important to note that this application runs in its own process and is not connected to the XBUS 1402 itself. The various XTRAN Server XCOMPs 1403-1419 call methods on the Fusion Data Server 1401 directly through the .NET remoting framework rather then using XML messaging.

Some Fusion installations may require multiple standalone Fusion mailroom operations. Each standalone operation may have its own XBUS 1402, components 1403-1419, Fusion Data Server 1401 and Fusion Database 1420. One Fusion system is designated as the primary system, which has knowledge of the other Fusions systems. The different XBUSes communicate through an XBUS Bridge component. XCOMPs in the primary system request and consolidate data from the secondary XBUS components on an as needed basis.

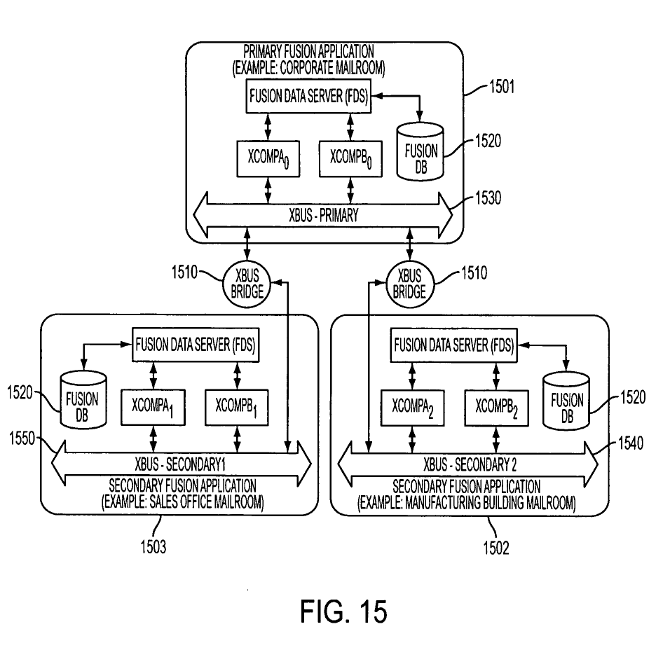

For example, as shown in FIG. 15, we have three separate Fusions systems 1501-1503, one primary 1501 and two secondary 1502, 1503, each secondary connected to the primary system through an XBUS bridge 1510. Each system is running the same components, and has its own database 1520.

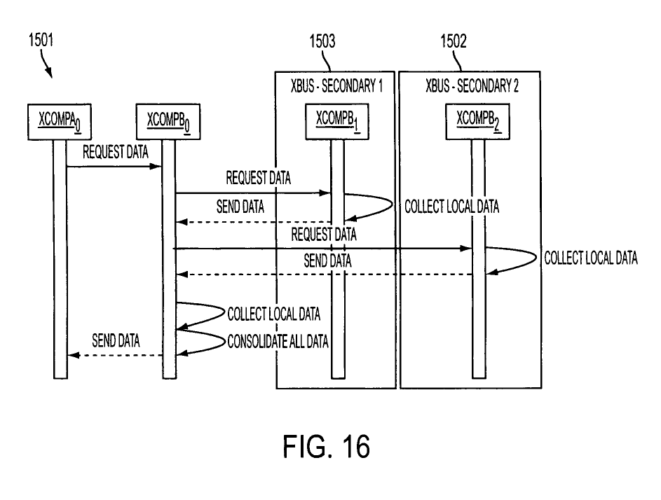

Now, let us suppose XCOMPA₀ in the primary system needs certain information that it normally gets from the local XCOMPB₀, but this time it is looking for information from all Fusions systems 1501-1503. It makes the request for the data from XCOMPB₀ on its local XBUS 1530. XCOMPB₀ is aware of all the corresponding XCOMPBs in the secondary systems. It collects it own data from the local XBUS 1530, and sends messages through the XBUS bridges 1510 to the secondary XCOMPBs, XCOMPB₁ and XCOMPB₂. The secondary system components respond as they usually do, with the response messages going back through the bridge 1510, to the primary XBUS 1530 component. The primary component, XCOMPB₀ then consolidates the information and returns it to the requester, XCOMPA₀. In this example the functionality concerning the multiple systems is all contained within the XCOMPB₀ component, and XCOMPA₀ has no direct knowledge of the other Fusion systems. Additionally, the components in the secondary system, XCOMPB₁ and XCOMPB₂, are also unaware they are fulfilling requests for a component in another Fusion system. A diagram on how this messaging would work is shown in FIG. 16.

Another example may have XCOMPA₀ aware of all XCOMPBs on all XBUS systems 1501-1503, primary and secondary. It then makes the requests to the multiple XCOMPBs, (XCOMPB₀, XCOMPB₁ and XCOMPB₂), receives all of the responses, some from the local XBUS 1530 and some through the bridge 1510, and consolidates the information for itself.

The primary system components and the individual XBUS bridges 1510 may know of the secondary systems, in this scenario. The secondary system components do not need to know anything of the primary system. They simply respond to messages and process requests as they normally would.

Referring back to FIG. 14, the Fusion Data Server (FDS) 1401 is different from other components in the Fusion architecture in that it is not an XCOMP. It does not receive and send messages to other components across the XBUS 1402. It is an object server that exposes remote object interfaces to the network, which can be used by other components on the network to access the database.

Its purpose is to provide a layer of abstraction to the database for the other components, so that they do not have to be concerned with the specific structure of the database, or the type of database server being used. By funneling all database activity through this layer, it allows the system to maximize resources by pooling database connections. The interfaces offered by this component depend on the actual data model for the database. These interfaces may be broken down into a number of different well-known objects, so that each component may only have to deal with those interfaces that it needs. The client components 1403-1419 may use a configuration file to find the server and identify the remote object they need. The Fusion Data Server (FDS) 1401 interacts with other components through NET remoting, by providing interfaces to objects that abstract the database to the client components. To the clients, it may appear as any other object, even though methods and properties are being accessed from the remote process. The Fusion Data Server (FDS) 1401 may not process any namespaces.

The purpose of the Fusion User Manager (FUM) 1409 is to manage user access to the Fusion system 1400. It prevents unauthorized users from using any FUSION application. It also controls what tasks a particular user can perform based on assigned privileges.

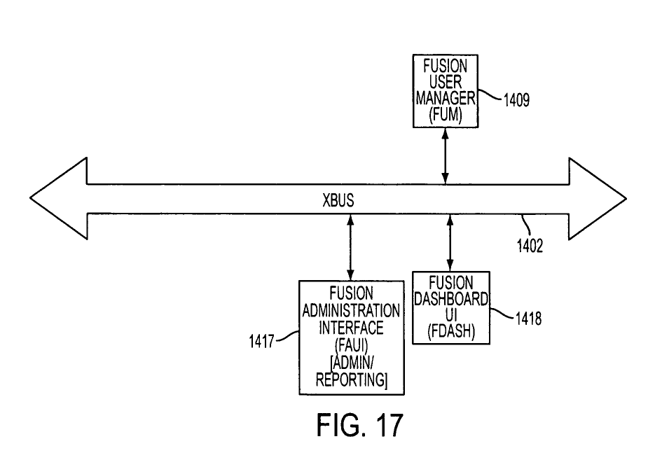

As shown in FIG. 17, the Fusion User Manager 1409 may interact primarily with the Fusion Admin User Interface(FAUI) 1417 component to create/modify user settings. In addition, other components that require Fusion User Authentication (e.g. Fusion Dashboard 1418) may interact with the FUM 1409.

A typical scenario would be as follows. The controller GUI requests the user Login ID and password. The controller GUI sends the Log ID and password to the FUM for authentication. The FUM 1409 sends back an authentication Pass/Fail message. If authentication passed the user has logged into the system. The controller GUI requests for privileges list for the logged in user. The controller GUI restricts functionality offered by the GUI based on the privileges of the user.

The Fusion Account/Budget Manager (FABM) 1407 may be an XTRAN server that may handle all of the business logic necessary for maintaining the hierarchical mailroom account/department data and associated budgeting information contained within. For example, the FABM 1407 may create new Fusion Department Accounts; edit existing Fusion Departmental Accounts; retire existing Fusion Departmental Accounts; provide Fusion Departmental Account Data to other components that require it; create Fusion Account Budgets; edit/Allocate existing Fusion Account budgets; create New Budget Periods; edit Existing Budget Periods; provide Account Validation Lists to Account Validator(s) as requested; and provide Account Validation List Deltas (additions/deletions) to Account Validator(s) as appropriate. (e.g. A budget overrun has occurred, or a new budget period has been entered).

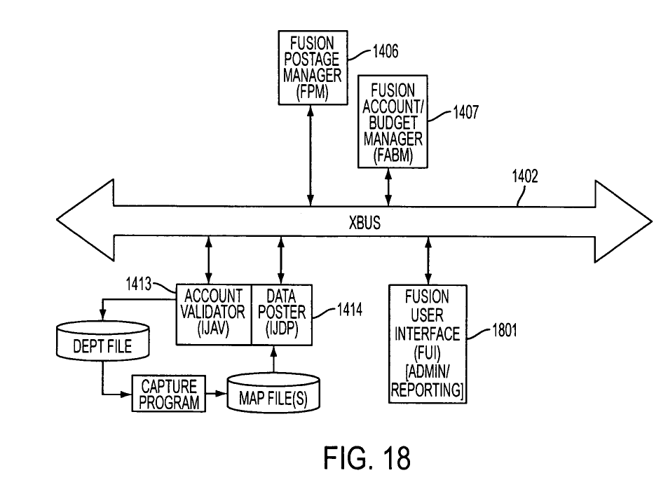

As can be seen in FIG. 18, the Fusion Account/Budget Manager 1407 interacts in a straight forward manner with the Fusion Admin User Interface 1801. In this situation the FABM 1407 provides all functionality to manage Fusion Accounts and Fusion Budgets.

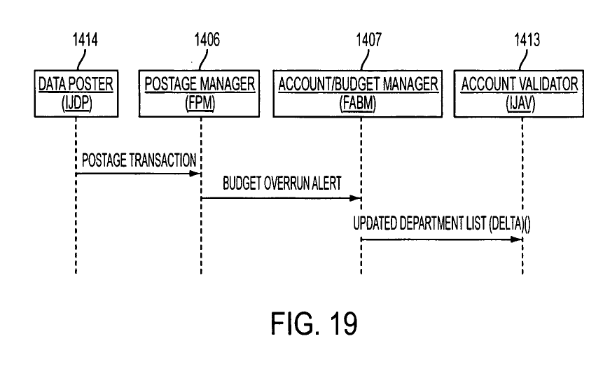

As can be seen in FIG. 19, in a more complex situation the Account/Budget Manager 1407 interacts with a number of components 1414, 1406, 1413 to provide Account/Budget validation at run time. In this scenario, while running postage, the Data Poster 1414 is posting transactions to the Postage Manager 1406. On each transaction, Budgets overruns are tested by the Postage Manager 1406. Upon an overrun, the Postage Manager 1406 issues a Budget Overrun Alert. This Budget Overrun Alert is detected by the Fusion Account Budget Manager 1407, resulting in an updated Department List to be created and sent out to all Account Validators. The Fusion.Account and Fusion.Budget namespaces may be handled by the Account/Budget manager.

The Fusion Configuration Manager (FCM) 1404 may handle various configuration information tasks for the system. This includes, but is not limited to, mailing machine, location and company information, display languages, global business rules and other settings.

When certain elements are changed, some events may be generated to indicate to other components that some configuration change has occurred. The other components may then have the opportunity to respond to these events, perhaps by reloading language features, or modifying their behavior from that point forward.

List of Features Supported by the FCM include for example, messages retrieving, adding and modifying location information; messages retrieving, adding and modifying mailing machine information; messages retrieving, adding and modifying company information; messages retrieving and modifying primary and secondary language information; and messages that modify globally applied business rules.

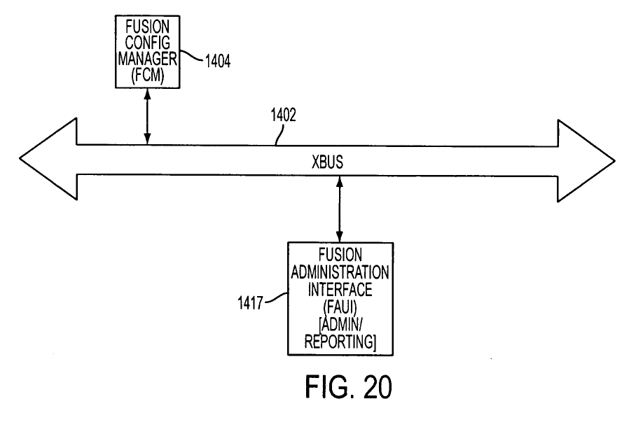

As shown in FIG. 20, the Fusion Configuration Manager (FCM) 1404 may interact with the Fusion Administrator UI (FAUI) 1417 as a front end for modifying the various configuration. It may produce events to be consumed by other components that are interested in when configurations change. The Fusion Configuration Manager (FCM) 1404 component handles Fusion.Configuration namespaces.

The Fusion Dashboard Manager (FDM) 1405 exists to support one or more Fusion Dashboards (FDASH) 1418. It does this by monitoring other components for information that may be displayed in the dashboard. This includes, but is not limited to, data such as operator logons, account updates, budget overruns, and machine operation. Other information is retrieved from the database using the Fusion Data Server (FDS) 1401, particularly on when the manager starts.

In this way, the Fusion Dashboard Manager (FDM) 1405 is a data repository for the information displayed by the Fusion Dashboard (FDASH) 1418. Since the Fusion Dashboard (FDASH) 14118 may change the information it monitors, or may be closed and opened again, the Fusion Dashboard Manager (FDM) 1405 needs to run continually, collecting information about real time operations even if no dashboard is currently interested in it.

At specific, configurable intervals, the Fusion Dashboard Manager (FDM) 1405 may send the information it has collected out to the XBUS 1402 as an event, to be consumed and displayed by any dashboards that have subscribed to such events.

The Fusion Dashboard Manager (FDM) 1405 may contain only the summary information about the various data that it can monitor. If the dashboard wishes to view summary information, it interacts with the component that handles that information. For example, even though the dashboard may be showing summary information for accounts, if the user of the dashboard then examines account details, the request may go to the Fusion Account/Budget Manager (FABM) 1407 for the information.

The dashboard can be configured to display or not display different information. This setup information is also handled by the Fusion Dashboard Manager (FDM) 1405 for validation and persistence. The dashboard may monitor account, budget, user and mailing machine information by subscribing to numerous XBUS messages generated by other components; interacts with the Fusion Dashboard (FDASH) 1418 to store, view and edit dashboard settings and options; and/or generate information events at configurable intervals with information for display in the dashboard.

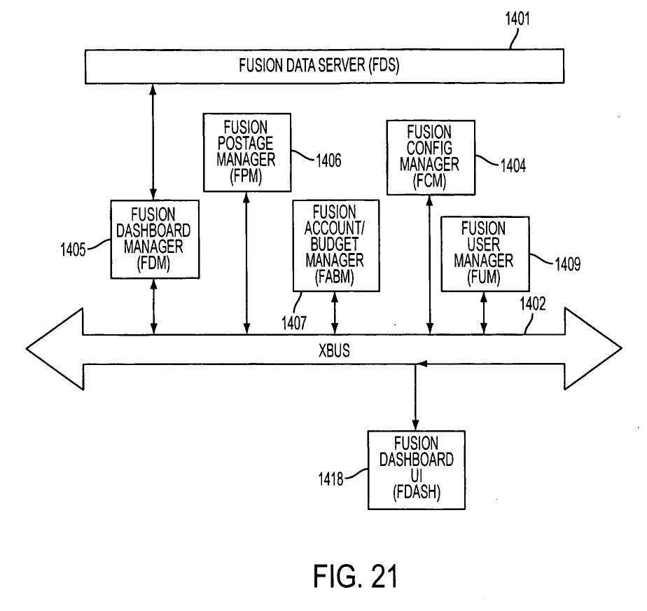

As can be seen in FIG. 21, the Fusion Dashboard Manager (FDM) 1405 interacts and listens to messages generated by other components passively, which is to say it does not directly request information from other XCOMPs 1406, 1407, 1409, 1418. It receives mailing machine, account and budget information from the Fusion Postage Manager (FPM) 1406, user events and information from the Fusion User Manager (FUM) 1409, mailing machine information from the Fusion Configuration Manager (FCM) 1404, and account and budget information from the Fusion Budget/Account Manager 1407. Additionally, some information is accessed directly from the database, using the Fusion Data Server (FDS) 1401. The Fusion Dashboard Manager (FDM) 1405 component may handle the Fusion.Dashboard namespaces.

Referring back to FIG. 14, the purpose of the Fusion Data Importer (FDI) 1403 is to take messages containing account, budget or transaction data and add it to the database. The data being imported may have come from the Fusion Data Exporter (FDE) (not shown), or another entity that provides data to be imported in the same format. The requestor is responsible for taking the data from some sort of persistent storage and translating it into messages the Fusion Data Importer (FDI) 1403 can interpret.

The Fusion Data Importer (FDI) 1403 imports the data in one transaction, or in multiple transactions, one per record. It also can import data in an overwrite or append operation.

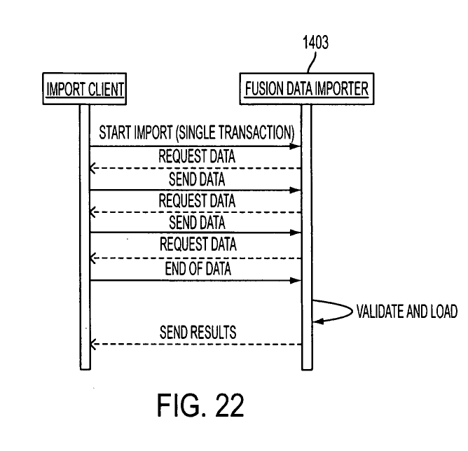

Depending on the amount of data to be imported, the requesting component may send the data to the Fusion Data Importer (FDI) 1403 in multiple messages, with the last message indicating the end of data, and any final parameters for importing the set. The Fusion Data Importer (FDI) 1403 may consolidate data as it receives it, persisting it locally for itself until the end of data is reached, if operating in single transaction mode. An example of the Fusion Data Importer (FDI) 1403 operating in a single transaction is shown in FIG. 22.

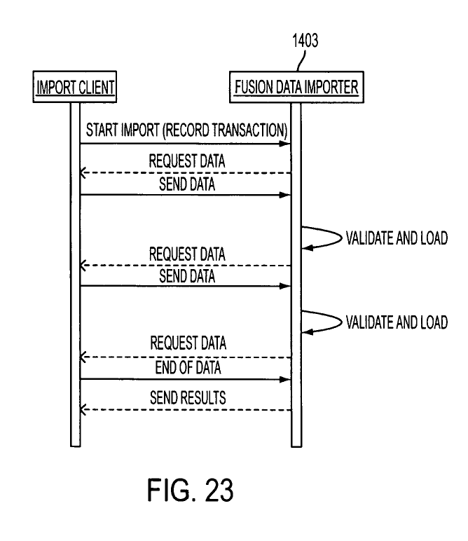

As shown in FIG. 23, when operating in record transaction mode, the Fusion Data Importer (FDI) 1403 can start importing the data as soon as it receives it.

The Fusion Data Importer (FDI) 1403 responds to the requestor with a message indicating success, or if there are errors, with information which indicates what records in the import data caused the errors and why. In all cases it may report the number of records successfully imported. The FDI 1403 may import account information; import budget information; import transaction information; rolling back all changes when errors occur in single transaction mode; rolling back single records changes when errors occur in multiple transaction mode; report the number of records successfully imported; and/or report the number of records causing errors, and the reason for the errors.

The Fusion Data Importer (FDI) 1403 receives messages from any component needing to import data into the database. It responds to those messages with information about the success or failure of the import.

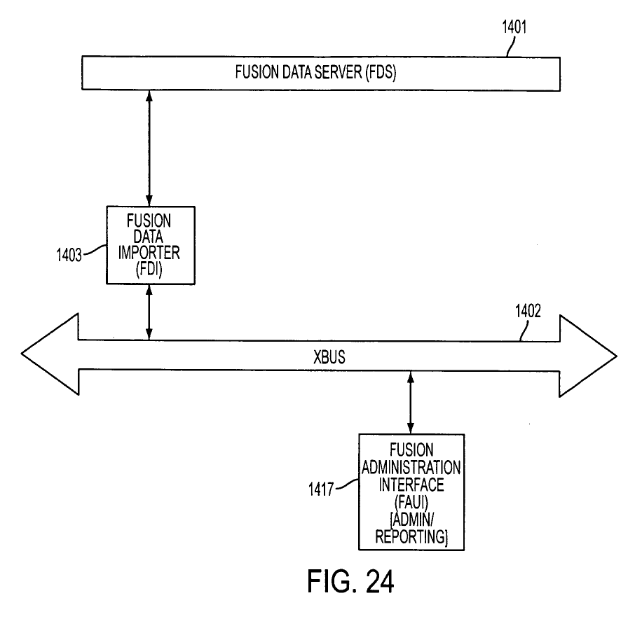

As can be seen in FIG. 24, the Fusion Data Importer (FDI) 1403 uses the Fusion Data Server (FDS) 1401 to interact with the database when importing and validating data. Typically this functionality may be accessed from the Fusion Admin UI (FAUI) 1417 which is where most import operations may be launched from. The Fusion Data Importer (FDI) 1403 component handles the Fusion.Importer namespaces.

The Fusion Postage Manager (FPM) 1406 exists to receive postage transactions from different franking machine capture programs and controllers. It receives this information and stores it into the Fusion Database.

The Fusion Postage Manager (FPM) 1406 may apply handling charges and/or surcharges on transactions as they are saved to the database, according to rules set up prior to the insert. These rules have criteria which determine which transactions receive these added charges, and well as the amount of the charge expressed as a flat fee or a percentage of the total postage of the original transaction. Such charges may be applied multiple times, depending on how many rules apply to the transaction.

The Fusion Postage Manager (FPM) 1406 may check if the transaction exceeds the budget associated with the transaction account, if budgeting is available, and generates an event on the XBUS 1402 to broadcast that a budget has been exceeded. A similar event is generated if the budget on a transaction reaches its notification threshold.

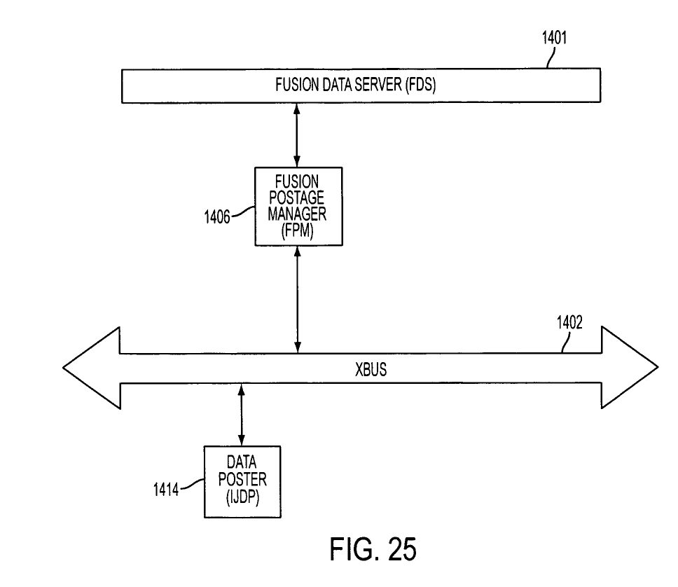

The Fusion Postage Manager (FPM) 1406 also generates an event on the XBUS 1402 for every transaction saved that indicates the amount charged, available, and budget for the account that was used in the transaction just saved. The FPM 1406 may receive transaction messages from meter components; search for surcharge/handling charge rules that match transaction being inserted and applies any additional charges; save modified transaction into the Fusion Database 1420; Raise a budget exceeded event when an account's budget has been exceeded; raise a budget warning event when an account's budget has come within the threshold value for notification; raise an account status event on transaction save to inform other components of the status of accounts; receives messages containing transactions from Data Posters(IJDP) 1414; interacts with the Fusion Data Server (FDS) 1401 to store transactions, and to apply additional charges to transactions; raise XBUS 1402 events if budgets are exceeded or are about to be exceeded, to which other components can subscribe; and/or raise XBUS 1402 events for the account in a transaction, giving the amount applied to the account, the budget, and the budget remaining, to which other components can subscribe. The Fusion Postage Manager (FPM) 1406 component handles the Fusion. Postage namespace. The interaction of the FPM 1406 with other components can be seen in FIG. 25.

The Capture Data Poster (IJDP) 1414 allows the legacy Capture program to move information onto the XBUS 1402. This component may continuously looks for files generated by the Capture program containing transactions. It then reads these files, parses the transaction information from them, reforms the information into an XBUS message, and then sends the message to the Fusion Postage Manager (FPM) 1406.

Since the format of the transactions in the Capture program may vary depending on the country or installation, the Capture Data Poster (IJDP) 1414 reads a configuration file on startup that maps the fields within the Capture files to the standard transaction message that is used by Fusion. This configuration file maps fields in the Capture file to fields in the Fusion transaction message, and may also perform translations of codes in the Capture file to standard codes used by the Fusion system 1400.

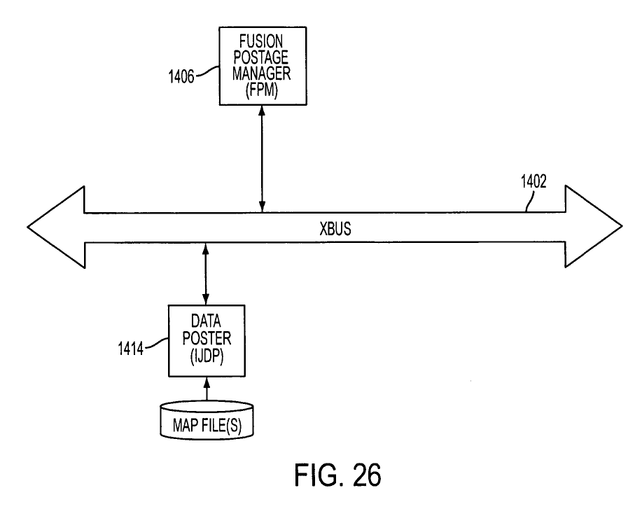

Once the file has been successfully processed, it may be moved to an archive location. The IJDP 1414 may monitor the output of the capture program for new capture files; parse the capture file according to a specific configuration, into a standard Fusion format suitable for use on the XBUS 1402, optionally translating codes in the original record to standard codes; and/or optionally move successfully processed captures files to an archive location. The interaction of the IJDP 1414 with other components can be seen in FIG. 26. The XBUS 1402 uses the services of the Fusion Postage Manager (FPM) 1406 to receive and store the transactions that the Capture Data Poster (IJDP) 1414 receives from the Capture program. The IJDP 1414 does not Process any namespaces. However, in alternate embodiments the IJDP 1414 may process any desired namespace.

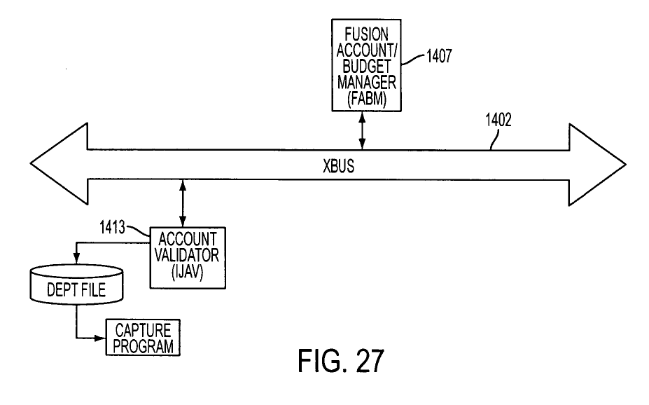

The Fusion Account Validator (IJAV) 1413 may be used to manage the Department List file that is used locally by the Capture.exe program. On startup, the IJAV 1413 may obtain the new Department List from the Account Budget Manager 1407. The IJAV 1413 may provide Account Validation List Deltas (additions/deletions) to Account Validator(s) as appropriate. (e.g. A budget overrun has occurred, or a new budget period has been entered). As can be seen in FIG. 27, the Account Validator 1413 interacts with the Account Budget manager 1407 to update local department file that is consumed by the Capture program. The IJAV 1413 handles the Fusion.AccountValidation namespaces.

The Fusion Administrator UI (FAUI) 1417 may be the user interface for managing the entire Fusion system 1400. It exists as a XCOMP that attaches to the XBUS 1402 and uses the services of almost all the XTRANs 1403-1416, 1418, 1419 in the system.

The Fusion Administrator UI (FAUI) 1417 may allow the user to manage logins and permissions, manage mailing machine configurations, manage locations, manage accounts and budgets, define and edit add-on charges, edit existing transactions, run reports, import and export data, and configure numerous system and dashboard options.

This functionality may enabled or disabled as needed based on the privileges of the user who has logged into the system. Individual choices presented in some screens may also be filtered by the privileges of the current user. The FAUI 1417 may add, delete, view, and edit user information; add, delete, view, and edit mailing machine information; add, delete, view, and edit location information; add, delete, view, and edit accounts and associated budgets; add, delete, view, and edit add-on charge rules; view and edit existing transactions; run, view, print, and save reports; import and export account and transaction data; and/or change settings regarding program operation, the Fusion Dashboard, company settings, and other business rules.

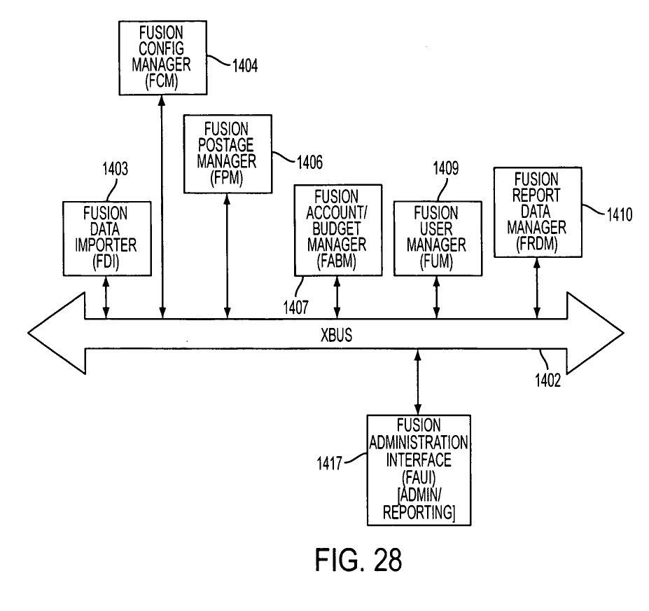

Since the Fusion Administrator UI (FAUI) 1417 represents the front end for almost every aspect of the system, it interacts with almost every other component as can be seen in FIG. 28. It is a client of the Fusion Data Importer (FDI) 1403 for importing account and transaction data. It uses the Fusion Account/Budget Manager (FABM) 1407 when viewing, editing, and adding account and budget information. It interacts with the Fusion User Manager (FUM) 1409 to modify user information, and for authorization of users. It uses the Fusion Report Data Manager 1410 to get the necessary data for reports, to create export files, and to search for information, and to filter a number of lists presented to the user. It makes use of the Fusion Postage Manager (FPM). 1406 to edit transactions. It uses the Fusion Configuration Manager (FCM) 1404 to manage various configuration data including mailing machine, location, and other miscellaneous configuration information. The Fusion Administrator UI (FAUI) 1417 does not process any namespaces. However, in alternate embodiments, the FAUI 1417 may process any desired namespaces.

Although the Report Viewer Component (part of FAUI) is part of the Fusion Administration user Interface component, it is separately treated here because of its complexity.

The Report Viewer component provides a Fusion user a way to view the various reports that are available in the Fusion system 1400. The Report Viewer component may be one of many components that are part of the main Fusion Admin User Interface application. The Report Viewer component may only be available for logged in users that have report viewing privileges.

The Report Viewer component may display a list of reports that the logged in user can execute. This list may contain the standard “canned” reports that the current user has permissions to execute. This list may also contain any saved (or memorized) reports that the current user has created; and/or allow the user the ability to generate reports that conform to parameters they specify (i.e. Date range, filtering, sorting, etc.). The report results may be viewable on screen in a control that allows the user to page through the report data as well as print the report to a local or network printer. Once the report results are displayed, the user may be able to save the settings that generated the report to the database. These saved reports may be given user defined name. These “memorized” reports may only be accessible to the user that created them. While viewing a report, it may allow the user to save the results as a PDF file. While viewing a report, it may allow the user to export the results into a delimited file. The actual delimiter may be configurable by the user along with whether the user wishes to have a header record. In all exported reports, only the report data is exported, no subtotal or grand total data may be exported. This way the export file may be uniform and easily consumed by some other program. While viewing a report, the data that created the report can be saved to disk. This data file can be later opened from the user's computer and viewed in the report viewer. The report data may be saved as an XML file. This XML file may contain an embedded schema for the data contained in the dataset. The XML data may also contain some metadata regarding the report itself including the class name and assembly that created the report as well as the settings that were in place when the report was generated. This metadata may be used when opening the report from disk to determine the proper ActiveReports report class that may run the report. The user may be allowed to email the results of a report in any suitable form including PDF, Export/Delimited File and Report Data XML File. Where appropriate, some of the reports may offer a graphical representation. For these reports, the user may be allowed to launch this graphical view from the report view. An Enterprise report can be created by selecting multiple report data files that may be consolidated into one report. Enterprise Reports consolidate summary data that is gathered from more than one Fusion site. This data is saved at each Fusion installation and then emailed to some central corporate site which may run the Enterprise report by consolidating multiple report data files into one large consolidated version. This new consolidated data is used to generate the Enterprise report. In future releases of Fusion, it may be possible to directly retrieve the data from the various Fusion sites by using an XBRIDGE. This may eliminate the need for the individual sites to email their local data file to the corporate site.

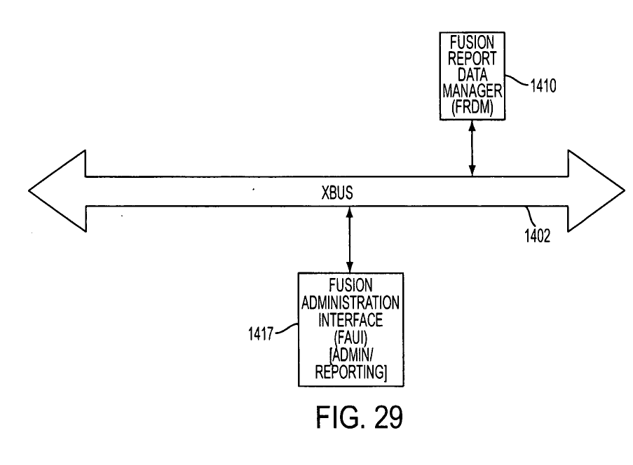

As shown in FIG. 29, the Report Viewer component of the FAUI 1417 may interact directly with the Report Data Manager component 1410, which is described below. The Report Data Manager 1410 may be used for retrieving a list of reports that is accessible to the logged in user and to retrieve the XML data that may be used as a report's data source.

The Report Viewer may also interact with the DLL(s) that contain the ActiveReport derived report classes. These DLL(s) are local to the report viewer and have methods that may generate the report. During the report generation process, these report DLLs may use a ReportDataManagerProxy to get the report data directly from the Report Data Manager.

The Report Viewer makes use of the “Fusion.ReportDataManager” message namespace in a message proxy capacity to get the list of reports that is accessible to a logged in user. When a report is selected to be viewed, it is the report itself (which is an ActiveReports derived class) that contains a message proxy to the “Fusion.ReportDataManager” to get the actual data used to generate the report. This namespace of messages may include the following messages:

GetReportList—This request message is used to get a list of reports that the logged in user can view in accordance with their privilege level. This request message may return a GetReportListResponse message.

GetReportListResponse—This is a response to the GetReportList request message. This message may contain all of the reports that the logged in user can view. The user may be able to view the report name, the Report category (i.e. Account, Mail Class, Job, Operator, etc.), a brief description of the report, the name of the assembly that contains the ActiveReport report definition, the class name that implements the ActiveReport, if the report is a “Memorized” report, the defined settings may also be included. The name may be a localized string for “canned” reports. The report category may be a localized string for the reports. The description of the report may be a localized string for “canned” reports.

ReportDataProcedure—This request message may be used to get the data associated with a specified report. This message provides a generic mechanism to specify the various settings of a report. This request may return a ReportDataResponse message.

ReportDataResponse—This message may return the XML data that is associated with the requested report. Since some reports can potentially require large amounts of data, this response message might only contain a portion of the overall data needed for the report, this is referred to as a “ReportDataChunk”. A “ReportDataChunk” may contain a portion of the actual report data along with a “ReportDataNextBlock” element that can be used as a parameter to the ReportDataNextRequest message which is used to retrieve the next sequential block of report data. “Chunking up” the data into smaller pieces makes it possible to pass arbitrarily large amounts of data across the XBUS. In these cases, the ReportViewer is responsible for piecing the data together in order to create the data source for the report.

ReportDataNextRequest—This message is used when the report data has been divided into “Chunks” (this was described above). When a ReportDataResponse message is received, the “ReportDataNextBlock” element (if it exists) is used in this message to get the next portion of the data for the report being generated.

ReportDataEndRequest—This message is used to end the process of getting data chunks for a specific report. When a request is made to the ReportDataManager for report data, the ReportDataManager may execute a query against the database that may return the entire result set. This result set is cached locally in the database and is separated into pieces (using the ReportDataNextRequest message) so that it can be passed efficiently via the XBUS 1402. Once all of the data has been retrieved, this message can be sent to clean up this cached data.

The following sequence describes a high level view of what takes place when launching the report list. When the user launches the Report Viewer from the GUI, the GetReportList method is called on the ReportDataManagerProxy passing in the user ID of the currently logged in user. This method may return a list of information regarding the reports that the passed in user can access. Iterating over this list, the assembly and class name of each report is retrieved and an attempt to dynamically load that class is made. If this is successful, then the report info associated with that report is cached in a local list of reports that the user can access. This list is cached locally so that the report list can be shown quickly when it is requested. When the user launches the Report List, the cached list of reports is bound to the GUI report list control in the Report List.

The following sequence describes a high level view of what takes place when viewing a specific report. When the user selects a report from the Report List for viewing, the ActiveReport inherited class is dynamically loaded. This report class is decorated with an attribute that specifies a NET user control that is used to obtain the report settings. If the report has an associated report settings user control, it is displayed to the user. If the report is a “Memorized” report, then the settings for the report may be defaulted to the settings found in the cached report information object. When the user accepts the report settings, the current settings are extracted from the Report Settings user control and set onto the Active Report derived report object. The Active Report derived class is then instructed to generate itself using a method call on the report object. When a report is being generated, the report class may first get the data that may source the report. The report class owns a ReportDataManagerProxy for this purpose. The process of getting all of the data for the report may be an iterative one in which that data is gotten in “Chunks” which are then consolidated into a single NET Dataset. During this process, the report first calls the ReportDataProcedure which may return the first “Chunk” of data along with an object that is used to get the next “Chunk” of data. From that point on, the ReportDataNextRequest method is called until all of the data is retrieved. Once all of the data has been retrieved, the ReportDataEndRequest method is called to clean up data that is being cached by the ReportDataManager. All of the data that is retrieved has been written out to a temporary file which is now read into a NET Dataset. This Dataset is now set as the data source for the report. After this the report object iterates over this data to create the actual report. Once the report has been created, it can be viewed using the ActiveReports report viewer control.

A report's data can be saved to a file so that it can be viewed at a later time. The ability to save a report's data to a file may be used for Enterprise Reporting.

The following is a high level description of what takes place when saving a files data to disk. While viewing a report in the report viewer, the user selects the “Save” option (either through a menu or a button). When this occurs the user is prompted for the location for the data file. The user inputs the location into a file save dialog and presses OK. The dataset that contains both the meta-data regarding the report and the actual report data is saved into an XML file along with the XML schema for this file. At some later point, the user can open this saved data file. When the file is opened, the report meta-data is examined to determine the ActiveReport class that may need to be instantiated to view the associated report. If the assembly and class are found (using NET Reflection), the associated class is dynamically loaded and its datasource is set to a dataset that is built from the opened XML file. The report is run and displayed to the user.

An Enterprise Report is used to create a report that consolidates the summary data from multiple Fusion installations. To create the Enterprise report, a report associated with the Enterprise consolidation report must be generated at each Fusion installation and its data save to disk. These datafiles may then be emailed or made accessible to one central corporate location that may be generating the consolidation report. Once all of these files are accessible, the Enterprise consolidation report can be created. The following is a high level description of how this Enterprise report is created.

From within the Report Viewer component, there may exist an option to create various Enterprise reports for users that have this privilege. Upon selecting the specific Enterprise report to generate, they may be presented with a way to select the multiple data files sent by the other Fusion installations. Once all of the files are selected, a quick check of the report meta-data in these files may be made to make sure that all of the data files correspond to the Enterprise report being generated. All of these data files may be consolidated into one data file. This new consolidated data file is set as the data source of the Enterprise report. Now the report can be run and viewed in the report viewer.

The Fusion Report Data Manager (FRDM) 1410 component acts as a data server to the ReportViewer. It is implemented as an XTran Server that can handle multiple simultaneous requests for data. This is of great benefit because there can exist many report viewers on the XBUS network. It is the Report Data Manager 1410 that is responsible for retrieving the list of reports that a specific user can access as well as retrieving the actual data used to create the report.

The FRDM 1410 may retrieve the list of reports that a specific user can access and/or retrieve the data associated with a specified report. For efficiently transporting potentially large amounts data that may be associated with a given report, the Report Data Manager 1410 has the ability to split the report data into smaller more manageable “Chunks”.

Since the Report Data Manager 1410 acts in a server capacity, it may not need to directly know about any other XBUS Components, it simply responds to the requests that it receives. The only known client of this component may be the ReportViewer although that does not prevent other components from utilizing the Report Data Manager 1410 to get data from the database.

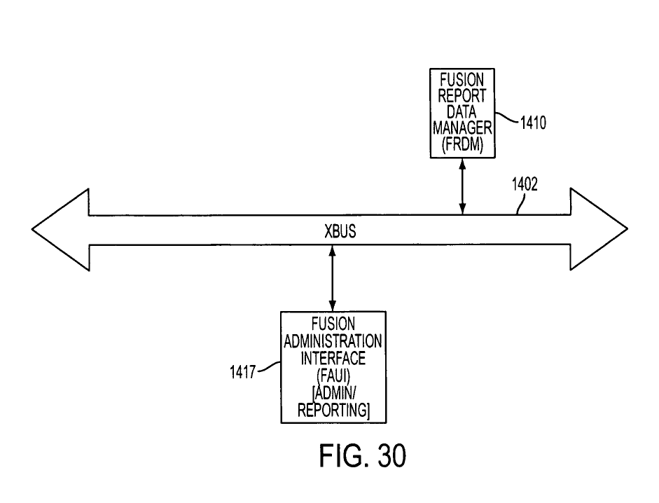

As shown in FIG. 30, the Report Data Manager 1410 does not interact with the database directly. Instead it uses NET Remoting to interact with a Fusion Data Server 1401 which acts as a proxy to the Fusion database 1420 (FIG. 14). All of the XBUS components that need direct access to the database 1420 use the Fusion Data Server 1401 for this purpose. This allows all of the connections to the Fusion database to live with one application domain making it possible to efficiently pool the database connections.

The Report Data Manager 1410 uses the “Fusion.ReportDataManager” message namespace in a message stub capacity to provide the implementation that is associated with the messages of this namespace. This message namespace is described in detail in the “Message Namespaces Processed” sub-section of the “ReportViewer” component.

The Fusion Dashboard (FDASH) 1418 is a GUI app which sits unobtrusively on a user's desktop and gives the user the summary status and health of the Fusion system 1400. It also allows the user to take any necessary action on any kind of event that requires user intervention.

The FDASH 1418 may restrict the user to certain functionality based on privileges. The user can view information for Accounts, Operators, Jobs and Mailing Machines. Examples of what a user sees on the FDASH 1418 are:

Accounts: User can see budget allocated and total funds used till date;

Operators: User can see if an operator is online and what job is being run;

Jobs: User can see total postage franked for a job and the status of it; and

Mailing Machine: User can get status of the mailing machine like register values.

The FDASH 1418 may allow the user to receive alerts and messages like in the case of low funds warning. The FDASH 1418 may allow the user to take actions based on alerts like sending a re-credit order when funds are low. The FDASH 1418 may allow users to choose UI skins and save the settings; shows operator info such as location, online status, total piece history, critical alert history and real time productivity; shows mailing machine info such as serial number, online status, active/inactive status, available funds, re-credit history and critical alert history; shows job info such as active/inactive status, real time productivity, location, critical alert history and operator running the job; show account info such as location, total budget, funds used, operators, alert history and action taken; and/or displays alerts and provides a mechanism for the user to respond to them.

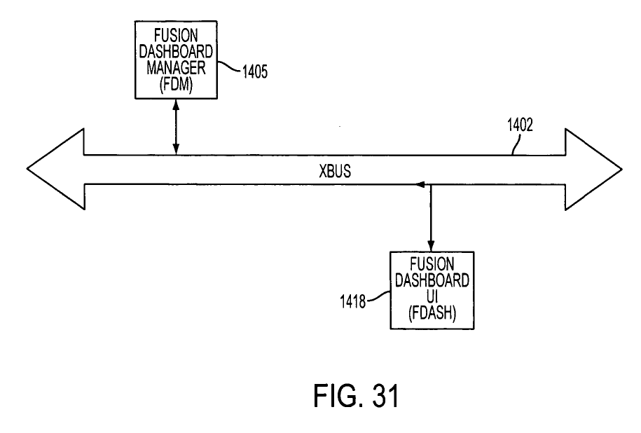

As can be seen in FIG. 31, the FDASH 1418 uses the Fusion Dashboard manager (FDM) 1405 to obtain info to display. The FDASH 1418 subscribes to the FDM 1405 to get events for alerts and warning messages. Since no other component subscribes to the FDASH 1418 it doesn't process any namespace.

The Fusion Logger Component (FLOG) 1408 is used to consolidate all application logging to a single log file. The FLOG 1408 may handle recording many different types of log events and may perform additional tasks for some special types of log entries. Since these log events provide useful information to the users of the Fusion system 1400, these log messages may be localizable.

The type of information that is FLOGed contains a broad range of activities that occur in the various XCOMPs system wide. Typical information logged might include: User Logged In; User Logged Out; Budget was changed; Batch was reassigned to another account; Error occurred; Meter is low on funds; A Batch was started; Etc.

The following is a list of the various types of activities that can be logged: Alarm; Error; Warning; Info; and Audit. In alternate embodiments, any desired activities may be logged.

The information logged by the FLOG 1408 may be saved to the database 1402. To prevent the database 1402 from getting too large, the number of records that can maintained in the log is fixed. Whenever a new log entry is added, the current number of entries is checked to see if the log table is at its maximum capacity and removes old records if necessary.

For some special types of events, some other action might also be taken in addition to storing an entry in the database. For instance, when an “Alarm” event is logged the FLOG 1408 may fire a Log Alert event message back onto the XBUS 1402. This may allow any other component (most likely the Dashboard) to display an alert to the user.

To provide some automatic logging capabilities, the FLOG 1408 may also subscribe to many important event messages that can occur in the system so that these can be logged without requiring a special log message to be sent to the FLOG 1408. For instance, the FLOG 1408 may automatically listen for event messages that are notifications of the following: a User has logged in; a User has logged out; a component has connected to the XBUS 1402; a component has disconnected; Etc.

The FLOG 1408 component may support the ability to listen in on event special event messages that occur on the XBUS 1402 to for automatic logging; supports messages that allow other XCOMPs to log activities to the FLOG 1408; and/or raises Alert event notification messages onto the XBUS 1402 when an “Alert” log event is saved.

The FLOG 1408 may be implemented as an XTran Server so that it can handle multiple logging requests simultaneously. As a server component, it does not have any direct knowledge of any other XCOMP on the XBUS 1402 network. In order to store log activities in the database, the FLOG 1408 may use the FusionDataServer as a proxy to the database.

The FLOG 1408 may use the “Fusion.Log” message namespace in a message stub capacity to provide the implementation for methods that are used to add an event activity to the database as well as to fire an event message when an “Alarm” activity is save.

The FLOG 1408 also uses many of the message namespaces throughout Fusion in a message proxy capacity to listen in on many of the messages that occur on the XBUS 1402. This makes it possible for the FLOG 1408 to automatically log events that occur within the XBUS 1402 network without requiring an XCOMP to send an explicit log message to the FLOG 1408.

The Fusion system may be used to collect piece statistics from Mailing Machines (MM) and store them in a database. This includes accommodating differing data formats due to differing mailing machine models as well as varying data requirements related to MM specifics per country. The exemplary embodiments may also provide a means for the management of system Users by locations and privilege levels. That is, users are associated with a location and may have various degrees of privilege/functionality. In addition, Fusion system may provide for the definition and maintenance of accounts. Accounts may be used to manage money which is being spent on the MMs. Accounts may have budgetary constraints. Money spent on the postage within MMs may be assigned to accounts for tracking and reporting purposes. The exemplary embodiments may also provide for easy monitoring of MMs, operators, and overall mailroom efficiency and provide reports by which mailing operations may be analyzed and accounts/departments charged.

The Fusion system may capture and store the mail accounting data from the MMs. One file is created for each different mail class. A Data Poster component 1414 whose job it is to detect the presence of new files, read them and send the data into a local database may also be provided. Once mail statistics data is in the database, the data may be protected against accidental or malicious modification/deletion. This may be accomplished by restricting external table access in the database to “read only”. In order to maintain data integrity in the database, a mechanism is provided for the regular backup of the data.

To secure against hardware failure of the database machine, there are three mechanisms available for a customer's choosing:
1. Regular Database backup functionality available with the particular database.
2. Hardware RAID disk capability to guard against disk failure
3. Database replication to a separate database machine (available only on some databases)

System reliability is determined by the hardware reliability as well as software robustness. There is no assumption here as to what the user's choice of hardware shall be. However, as to the robustness of the software the following elements and development practices may be employed in the exemplary embodiments. Underlying use of the Event Logger and Application Logger (further described later in this document) allow for extensive monitoring of proper software functionality both during development as well as in field deployment, leading to timely resolution of software bugs. These logs may be available to technical support personnel to determine if user complaints are due to customer mistakes/misunderstanding or software bugs. Dynamic monitoring of software components through the use of “watchdog” messages in order to quickly uncover “dead” applications and provide feedback to the user. Extensive reuse of code to minimize “sleeper” bugs. All elements are highly modular and unit tested by specifically written test applications. These test applications used by developers for debug purposes may also be used by QA personnel to thoroughly test various parts of the system through “stress” testing. An example of a stress test is the use a of a MM simulator which injects “mailing machine data” at a much faster rate than the actual mailing machines.

The Fusion system may employ a commercial software update system. This provides a customer with the ability determine if new software is available and secondly to update their system at will by downloading the updates from an Update Server

Due to the use of the XBUS, new functional components (XCOMPs) can easily be added without effecting existing components. The whole system is designed to evolve in functionality by the addition of new components. This is possible because each XCOMP that is added to the system only needs a connection to the XBUS itself to participate in messaging with all other XCOMPs in the system.

Not only is the system extensible by adding new functional components, the messages themselves are also extensible. This allows the ability to add information to an existing XBUS message without adversely affecting any XCOMP that is already utilizing that message. This is all possible because XBUS messages are built using XML. The various XBUS messages are designed through the use of XML Schema to be expandable as long as the existing parts of a particular message are not changed.

Since the XBUS utilizes TCP/IP protocol, components (XCOMPS) may be located anywhere within a network thus utilizing the horsepower of multiple computer systems. Also, the XBUS allows for multiple buses running on multiple machines with bridges between, again providing for powerful scalable solutions. These bridges provide a controlled mechanism to propagate selected messages from one XBUS to another.

The exemplary embodiments may also provide internationalization. Internationalization is comprised of two major areas of interest, they are language and culture. Language may mean the textual content of the applications may be able to support multiple languages. Culture may mean the information may be displayed to the user in a format that is consistent with their geographic location. This may include such things as how dates are formatted (i.e. MM/DD/YYYY or DD/MM/YYYY) and how currency is formatted.

To accomplish this goal of Internationalization, the various applications may leverage the global resource handling functionality built into the NET. NET provides a means to access resources based on a user's location. Much of this is handled using the Resource Manager class that is part of the .NET Framework.

The components of the system that contain user-viewable information may provide localized resources whether the component has a user-interface or not.

The language displayed to the user may be controlled by setting the specific culture and language on the current UI thread. Once this is set, the application may behave in a way that is consistent with that culture and language. If there is no language/culture specific resource associated with a specific UI element of interest, then the default resource using US English may be used.

Whenever a user logs into the system, the application may authenticate that user. This authentication may occur by sending a User Authentication request message to the Fusion User Manager (FUM). In this message, both the Username and Password may be sent. The FUM returns a response to the User Authentication request message to indicate whether the user is valid and the privileges assigned to that user.

All components that connect to the XBus have to undergo an authorization handshake in order for the XBus to determine that the connecting component is created or sanctioned by Neopost.

Any suitable operating system may be used in the exemplary embodiments. Due to the use of the XBUS, future components written in any language and running on any operating system may connect to the system of the exemplary embodiments as long as they conform to the XBUS message protocol.

Any suitable database system may be used with the system of the exemplary embodiments. A database abstraction layer may be used so as not to preclude other database systems from being used at some future date.

The XCOMPs created for use in the exemplary embodiments may be built using the NET Framework. It is important to note although all of the Fusion XCOMPs may be built using NET, it does not preclude other XCOMPs from being written using any other platform/language as long as those components are capable of TCP communication using Xml messages that comply with the XBus message protocol.

The Web components of the system of the exemplary embodiments may utilize a built in version of IIS (Internet Information Server). It is important that the IIS be NET enabled.

Use of the XML Message Bus is employed by XCOMPs to communicate with each other. Depending on system configurations, multiple buses may be employed and bridged together thus allowing for comprehensive connectivity while isolating local bus traffic.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A method for communicating between applications on a network comprising:
providing a first server having associated applications;
providing a second server having associated applications;
bridging the first and second servers together with a bridge functionality having at least one subscription list;
sending a message from at least one of the associated applications on the first server to the first server;
sending the message to the associated applications on the first server subscribing to the message and to the bridge functionality;
adding the message to the at least one subscription list; and
sending the message to the second server and the associated applications on the second server that subscribe to the message;
wherein the bridge functionality determines if the message is to be sent to the second server and the associated applications on the second server.

2. The method of claim 1 wherein the message is an XML message.

3. A computer network comprising:
a first server having associated applications
a second server having associated applications; and
a bridge functionality having at least one subscription list, the bridge functionality connecting the first and second server;
wherein the bridge functionality determines if a message is to be sent from the first server to the second server.
